(19) United States
(12) Patent Application Publication
(10) Pub. No.: US 2024/0329551 A1
(43) Pub. Date: Oct. 3, 2024

(54) TONER AND TWO-COMPONENT DEVELOPER

(71) Applicant: CANON KABUSHIKI KAISHA, Tokyo (JP)

(72) Inventors: KENTARO KAMAE, Kanagawa (JP); KENTA MITSUIKI, Fukuoka (JP); NOBUHIRO YOSHIDA, Ibaraki (JP); MAKI IMURA, Kanagawa (JP); KOHEI YOSHIYAMA, Chiba (JP); YUU NISHIMURA, Chiba (JP); KAZUNARI OOYAMA, Ibaraki (JP); NOBUYOSHI SUGAHARA, Tokyo (JP); YUYA CHIMOTO, Chiba (JP); TAKAHO SHIBATA, Tokyo (JP)

(21) Appl. No.: 18/613,681

(22) Filed: Mar. 22, 2024

(30) Foreign Application Priority Data
Mar. 31, 2023 (JP) 2023-057837

(51) Int. Cl. G03G 9/087; G03G 9/107

(52) U.S. Cl. CPC G03G 9/08724; G03G 9/08755; G03G 9/1075

(57) ABSTRACT

A toner is provided, which has a toner particle that contains a binder resin which contains an amorphous resin A and a crystalline polyester C, wherein the amorphous resin A and the crystalline polyester C each has a structure of a specific straight-chain aliphatic polyhydric alcohol, the amorphous resin A has a structure in which a polyester is crosslinked with a vinyl polymer, and the melting point of the crystalline polyester C and the weight-average molecular weight of the amorphous resin A lie within respective specific ranges.

### BACKGROUND OF THE INVENTION

### Field of the Invention

The present disclosure relates to a toner used, for instance, in electrophotographic systems, electrostatic recording systems and electrostatic printing systems, and relates to a two-component developer that utilizes that toner.

### Description of the Related Art

In recent years, the growing spread of electrophotographic full-color copiers has been accompanied by a demand for improvements in terms of additional performance not only in terms of higher speeds and better image quality but also in terms of energy savings and compatibility with various media.

Specifically toners that exhibit excellent low-temperature fixability and that allow for fixing at lower temperatures are demanded as toners that afford energy savings for the purpose of reducing power consumption in a fixing process. Moreover, heavy coated paper, which is herein one kind of various media, contains large amounts of inorganic fine particles of calcium carbonate or the like for the purpose of enhancing whiteness; accordingly, forces of friction between paper and an image are large, and the toner in a fixed image peels readily off the paper. Toners having excellent abrasion resistance are therefore demanded for the purpose of suppressing toner peeling derived from rubbing between paper sheets.

Such being the case, Japanese Patent Application Publication No. 2018-156074 proposes a toner that utilizes a crystalline polyvinyl resin, as a toner having excellent low-temperature fixability. Further, Japanese Patent Application Publication No. 2016-197207 proposes a toner that exhibits excellent abrasion resistance, in the form of a toner having an alkenylsuccinic acid as a carboxylic acid component of a polyester.

### SUMMARY OF THE INVENTION

The toner disclosed in Japanese Patent Application Publication No. 2018-156074 utilizes a highly hydrophobic crystalline polyvinyl resin having a sharp melt property, and because of such a feature the toner can bring out excellent low-temperature fixability. Crystalline polyvinyl resins have high affinity to waxes, and, as a result, wax exudation is suppressed and a wax layer does not form readily on the surface of a fixed image, hance it has been found that abrasion resistance may be poorer as a result.

The wax in the toner disclosed in Japanese Patent Application Publication No. 2016-197207 is likelier to be held on the fixed image than to migrate towards a fixing roller at the time of fixing, due to the high affinity of alkenylsuccinic acids to waxes. Therefore, a certain effect on abrasion resistance can be elicited in paper types such as thin paper. On the other hand, the toner disclosed in Japanese Patent Application Publication No. 2016-197207 does not contain a plasticizer such as a crystalline polyester; even if it did, crystallization would be promoted by the alkenylsuccinic acid, and the envisaged plasticizing effect may however fail to be elicited, whereby low-temperature fixability may be impaired as a result.

The above reveals that it is problematic to satisfy both low-temperature fixability and abrasion resistance. There is, accordingly, a pressing need to develop a toner that exhibits excellent low-temperature fixability and abrasion resistance. The present disclosure provides a toner that exhibits excellent low-temperature fixability and abrasion resistance, and provides a two-component developer that contains the toner.

The present disclosure relates to a toner comprising a toner particle comprising a binder resin, wherein
the binder resin comprises an amorphous resin A and a crystalline polyester C,
the crystalline polyester C has, as a structure that forms a polyester, a structure corresponding to a straight-chain aliphatic polyhydric alcohol (c);
a carbon number Cc of the straight-chain aliphatic polyhydric alcohol (c) satisfies Expression (1) below:

$$2 \leq C c \leq 6 \qquad ( 1 )$$

the amorphous resin A has, as a structure that forms a polyester, a structure corresponding to a straight-chain aliphatic polyhydric alcohol (a);
a carbon number Ca of the straight-chain aliphatic polyhydric alcohol (a) satisfies Expression (2) below:

$$2 \leq Ca \leq 10 \qquad ( 2 )$$

such that the Ca and the Cc satisfy Expression (3) below:

$$0 \leq \vert Ca - Cc \vert \leq 4 \qquad ( 3 )$$

the amorphous resin A has a structure in which a polyester is crosslinked with a vinyl polymer;
a weight-average molecular weight MwA measured from a tetrahydrofuran-soluble fraction of the amorphous resin A satisfies Expression (4) below:

$$10000 \leq MwA \leq 100 \; 000 , \qquad ( 4 )$$

and
a melting point Tc of the crystalline polyester C satisfies Expression (5) below:

$$90 ° C . \leq Tc \leq 100 ° C . \qquad ( 5 )$$

The present disclosure can provide a toner that exhibits excellent low-temperature fixability and abrasion resistance, and provides a two-component developer that contains the toner. Further features of the present invention will become apparent from the following description of exemplary embodiments.

### DESCRIPTION OF THE EMBODIMENTS

In the present disclosure, the expression of “from XX to YY” or “XX to YY” indicating a numerical range means a numerical range including a lower limit and an upper limit which are end points, unless otherwise specified. Also, when a numerical range is described in a stepwise manner, the upper and lower limits of each numerical range can be arbitrarily combined. In addition, the monomer unit refers to a reacted form of the monomer substance in the polymer. In addition, the crystalline polyester is a resin that exhibits a clear endothermic peak in differential scanning calorimetric measurement (DSC).

The inventors have conducted ongoing studies on toners that exhibit excellent low-temperature fixability and abrasion resistance.

The inventors tackled first the approach of conferring the toner with greater resistance towards abrasion phenomena, by increasing the mechanical strength of the toner. The inventors found that a molecular weight equal to or higher than a given value is required in order to achieve an abrasion resistance effect; in turn, this may translate into a higher glass transition temperature and into a higher softening point of the toner, and into poorer low-temperature fixability.

The effect elicited when a wax, which is a material with low surface energy among the materials that make up the toner, is left on the surface of a fixed image, was studied next. Specifically, by lowering the melting point of the wax, exudation thereof onto the surface of a fixed image can be promoted also in situations where the toner does not readily heat up, for instance in heavy paper; a certain effect on abrasion resistance could be achieved as a result. However, exudation of the wax onto the surface of a fixed image is excessive in situations where the toner readily heats up, such as in the case of thin paper. It was found that, in consequence, the liquefied wax at the time of melting flows down onto the paper surface in halftone images, which are dot images with few adjacent toner particles, and as a result the wax cannot be supported on the toner, and abrasion resistance is impaired.

When on the other hand the melting point of wax is raised, the liquefied wax solidifies quickly, and does not flow down on the paper surface, also in situations where the toner readily heats up, for instance on thin paper; as a result, the wax could be supported on the fixed image, and a certain effect on abrasion resistance was obtained. When the melting point of the wax is raised, however, wax exudation onto the fixed image surface is suppressed and a wax layer does not form readily on the fixed image surface, in situations where the toner is does not readily heat up, for instance in heavy paper; abrasion resistance is impaired as a result.

In other words, it became apparent that it is difficult to bring out excellent abrasion resistance, also in various fixed images and paper types, just through control of exudation based on the melting point of the wax.

Therefore, the inventors conducted further studies for elucidating the underlying mechanism for the above abrasion phenomenon, and ascertained the manner in which a wax exhibiting low surface energy contributes to enhancing abrasion resistance. Specifically, the inventors analyzed not only abraded fixed images boasting excellent abrasion resistance, but analyzed also the abraded paper side.

It was revealed as a result that although a toner component was absent also in paper from which a fixed image was abraded, a wax component was nevertheless present thereon. That is, the presence of a wax of low surface energy on a fixed image of excellent abrasion resistance does not imply that the fixed image undergoes no abrasion. It was found that although the fixed image was abraded, abrasion phenomena were confined to the outermost surface layer of the image, and did not reach into a toner layer, thanks to the presence of the wax layer that is readily scraped off; this translated as a result into superior abrasion resistance.

The inventors further delved into the underlying physical properties from which the wax derives the functionality of being readily scraped and of having abrasion phenomena be confined to the outermost surface layer, and investigated wax materials. It was revealed as a result that the functionality of the wax does not derive from the composition thereof in terms of low surface energy, but derives from the material structure of the wax, in terms of being crystalline or amorphous.

Specifically, it was found that also crystalline polyesters, having ester groups and exhibiting a surface energy that is not low, bring out a similar functionality. That is, a requirement became apparent whereby a material must have crystallinity in order to bring out a similar functionality. The underlying reason for this is that, similarly to crystalline materials, the molecules of the material become folded in an orderly manner; as a result, the material is readily scraped in an orderly manner also during abrasion, and abrasion phenomena can be confined to the outermost surface layer. It was found that this functionality can be expressed, as a physical property, in the form of a friction coefficient, and it was revealed that waxes and crystalline polyesters have friction coefficients that are sufficiently lower than those of amorphous polyesters or the like.

In view of the above findings, the inventors set aside studies for increasing the mechanical strength of toner and studies for causing a wax of low surface energy to be supported on the surface of a fixed image, and turned to study in detail how to cause a crystalline polyester having crystallinity to be supported on the surface of a fixed image. That is because crystalline polyesters exhibit higher material selectivity than waxes, and the melting point and polarity of crystalline polyesters can be modified more easily; in consequence, an abrasion resistance effect could arguably be achieved herein that cannot be achieved through exudation control based on the melting point of the wax.

However, it was revealed that when a crystalline polyester is made inter-soluble with an amorphous resin, the crystalline polyester acts then as a plasticizer to the amorphous resin; although this results in excellent low-temperature fixability, the crystalline polyester does no longer crystallize readily, and in consequence the effect of a low friction coefficient cannot be achieved, and abrasion resistance worsens. When on the other hand the crystalline polyester is caused to undergo phase separation from the amorphous resin, the crystalline polyester does not act as a plasticizer to the amorphous resin, and in consequence low-temperature fixability is impaired as a result. Furthermore, the crystalline polyester has low affinity towards the amorphous resin, and accordingly the crystalline polyester behaves like a wax, such that the crystalline polyester cannot be supported on dots, and flows down the paper surface. It was revealed that, as a result, a layer of crystalline polyester fails to be formed on the surface of the fixed image, and abrasion resistance is impaired.

That is, despite the fact that the crystalline polyester and the amorphous resin dissolve in each other at the time of melting, the inventors recognized the need for the crystalline polyester to nevertheless crystallize readily and solidify quickly, during cooling, so that the crystalline polyester can be supported on the fixed image, without flowing down onto the paper surface. Amorphous resins and crystalline polyesters that can satisfy such relationships are thus essential herein.

On the basis of further studies, the inventors sorted out chronologically the phase changes of a crystalline polyester. Specifically, the crystalline polyester must inter-dissolve, in terms of low-temperature fixability, but must undergo phase separation and crystallization in terms of abrasion resistance. Phase changes for inter-solubility/phase separation have to take place over a short period of time, from after passage through a fixing nip until piling onto a paper output tray.

The inventors speculated that adjustments of the polarity of the amorphous resin and of the crystalline polyester are merely tantamount to moving along a trade-off line between inter-solubility and phase separation, but offer no prospect of achieving both low-temperature fixability and abrasion resistance, and accordingly the inventors delved more deeply into the issue. The inventors found as a result that low-temperature fixability and abrasion resistance can be both achieved by using a specific amorphous resin and a specific crystalline polyester.

Specifically, by imparting the below-described specific structure to a crystalline polyester, and by controlling the melting point thereof, a crystalline polyester was developed as a result in which intermolecular cohesion was increased and molecular folding was promoted, such that the crystalline polyester crystallizes in a short time from after passage through the fixing nip until piling on a paper output tray.

Further, by imparting the below-described specific structure to an amorphous resin, an amorphous resin was developed such that, upon entering in the fixing nip, the crystalline polyester inter-dissolves with the amorphous resin even when using a fast-crystallizing crystalline polyester such as the one above. The amorphous resin was configured through crosslinking of a polyester with a vinyl polymer. In consequence, the vinyl polymer that constitutes crosslinked portions does not inter-dissolve with the crystalline polyester. Therefore, the molecular mobility of crosslinking points of the amorphous resin does not increase, and the crystalline polyester that is crystallizing with phase separation from the amorphous resin can be prevented from exuding from the toner, at the time of piling on the paper output tray after passage through the fixing nip.

Specifically, the toner of the present disclosure has a toner particle containing a binder resin, such that the binder resin contains an amorphous resin A and a crystalline polyester C.

The crystalline polyester C has a structure corresponding to a straight-chain aliphatic polyhydric alcohol (c), as a structure that follows a polyester, such that the carbon number Cc of the straight-chain aliphatic polyhydric alcohol (c) satisfies Expression (1) below.

$$2 \leq Cc \leq 6 \qquad ( 1 )$$

The melting point Tc of the crystalline polyester C satisfies Expression (5) below.

$$90 ° C . \leq Tc \leq 100 ° C . \qquad ( 5 )$$

When the carbon number Cc of the straight-chain aliphatic polyhydric alcohol (c) lies within the above range, the intermolecular cohesion of the crystalline polyester increases, molecular folding is promoted, and crystallization takes place in a short time from after passage through the fixing nip until piling on the paper output tray. As a result, the effect of a low friction coefficient can be achieved, and excellent abrasion resistance can likewise be achieved. Preferably, Cc is 2 to 4, more preferably 2 to 3, and is yet more preferably 2.

The structure that forms the polyester is a structure that forms ester bonds. The structure corresponding to the straight-chain aliphatic polyhydric alcohol (c) is a structure, in the polyester, resulting from condensation of the straight-chain aliphatic polyhydric alcohol (c). The structure corresponding to the straight-chain aliphatic polyhydric alcohol (c) is for instance represented by Formula (I) below. The polyester can also be regarded as having a monomer unit corresponding to the straight-chain aliphatic polyhydric alcohol (c). Preferably, the straight-chain aliphatic polyhydric alcohol (c) is a straight-chain aliphatic diol having a carbon number Cc.

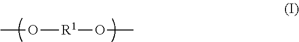

In Formula (I), R¹ is a straight-chain hydrocarbon group having carbon number Cc.

When the Tc of the crystalline polyester C is 90° C. or higher, the intermolecular cohesion of the crystalline polyester C increases, molecular folding is promoted, and crystallization takes place in a short time from after passage through the fixing nip until piling on the paper output tray. As a result there is achieved the effect of lowering the friction coefficient, and also excellent abrasion resistance is achieved. When Tc is 100° C. or lower, there is no longer a need for a substantial amount of heat until melting of the crystalline polyester C and plasticization of the polyester of the amorphous resin A, and hence excellent low-temperature fixability can be achieved.

Further, Tc is preferably 90 to 96° C., more preferably 91 to 94° C.

The amorphous resin A has a structure corresponding to a straight-chain aliphatic polyhydric alcohol (a) as a structure that forms a polyester; and

a carbon number Ca of the straight-chain aliphatic polyhydric alcohol (a) satisfies Expression (2) below.

$$2 \leq Ca \leq 10 \qquad ( 2 )$$

Further, Ca and Cc satisfy Expression (3) below.

$$0 \leq \vert Ca - Cc \vert \leq 4 \qquad ( 3 )$$

When the carbon number Ca of the straight-chain aliphatic polyhydric alcohol (a) lies within the above range and also |Ca-Cc| lies within the above range, this signifies that the amorphous resin A has a structure exhibiting high affinity to the crystalline polyester C. As a result, the above-described crystalline polyester C having a high degree of crystallinity enters the molecular chains of the amorphous resin A via a high-affinity structure that is locally present, and inter-dissolves with the amorphous resin A, thus bringing about a plasticizing effect by virtue of which excellent low-temperature fixability can be achieved. Further, Ca is preferably 2 to 6, more preferably 2 to 4, and yet more preferably is 2. Herein |Ca-Cc| is preferably 0 to 2, and is more preferably 0. The straight-chain aliphatic polyhydric alcohol (a) is preferably a straight-chain aliphatic diol having a carbon number Ca.

The amorphous resin A has a structure in which a polyester is crosslinked with a vinyl polymer.

When the amorphous resin A has the above structure, the crystalline polyester C inter-dissolves with the polyester contained in the amorphous resin A, whereas the vinyl polymer which is a crosslinked portion included in the amorphous resin A does not inter-dissolve with the crystalline polyester C. As a result, the molecular mobility at crosslinking points of the amorphous resin A does not increase, and the crystalline polyester C that is crystallizing with phase separation from the amorphous resin A does not readily exude from the toner, at the time of piling on the paper output tray after passage through the fixing nip. Therefore, the crystalline polyester C does not flow down onto the paper surface, but can be supported on the fixed image, which results in in excellent abrasion resistance.

The weight-average molecular weight MwA of the amorphous resin A as measured from a tetrahydrofuran-soluble fraction (THF-soluble fraction) thereof satisfies Expression (4) below.

$$1000 \; 0 \leq MwA \leq 1 \; 00000 \qquad ( 4 )$$

The molecular mobility of the crosslinked amorphous resin A can be suppressed in a case where MwA of the amorphous resin A is 10000 or higher. Accordingly, the crystalline polyester C that is crystallizing with phase separation from the amorphous resin can be prevented from exuding from the toner, at the time of piling on the paper output tray after passage through the fixing nip. Therefore, the crystalline polyester C does not flow down onto the paper surface, but can be supported on the fixed image, which results in in excellent abrasion resistance. In a case where MwA is 100000 or lower, excellent low-temperature fixability can be obtained by virtue of the fact that the molecular weight of the amorphous resin is not too high and at the same time the molecular mobility of the amorphous resin is curtailed.

Herein MwA is preferably 12000 to 50000, more preferably 15000 to 25000.

Preferably, the crystalline polyester C satisfies one or both of (A) and (B) below.

(A) The crystalline polyester C is a modified crystalline polyester having a structure resulting from condensation (terminal modification) of an aliphatic monocarboxylic acid having a carbon number of 15 to 31 (more preferably of 18 to 26, yet more preferably of 20 to 24) with a hydroxy group at a terminus of the main chain.

(B) The crystalline polyester C is a modified crystalline polyester having a structure resulting from condensation (terminal modification) of an aliphatic monoalcohol having a carbon number of 15 to 30 (more preferably of 18 to 26, yet more preferably of 20 to 24) with a carboxy group at the terminus of the main chain.

In a case where the crystalline polyester C is the above modified crystalline polyester, the main chain terminus acts like a crystal nucleating agent, and folding of the main chain is thus promoted. In consequence, the crystallization rate of the crystalline polyester C increases, and accordingly crystallization occurs more readily in a short time from after passage through the fixing nip until piling on the paper output tray. As a result there is achieved the effect of lowering the friction coefficient, and yet better abrasion resistance is achieved. A polarity difference with respect to the amorphous resin A can be ensured herein, and hence the crystalline polyester C can be easily caused to function as a crystal nucleating agent such that the amount of crystal nucleating agent at the main chain terminus can be controlled to an appropriate amount. In consequence, the crystallization rate of the crystalline polyester C can be increased, and crystallization takes place in a shorter time. As a result there is achieved the effect of lowering the friction coefficient, and yet better abrasion resistance is achieved.

In the amorphous resin A, preferably, the vinyl polymer that forms a crosslinked structure has a structure corresponding to a (meth)acrylic acid, as the structure that forms the vinyl polymer. The structure that forms the vinyl polymer is a structure resulting from addition polymerization of a monomer. The structure corresponding to a (meth)acrylic acid is a structure resulting from addition polymerization of a (meth)acrylic acid in the vinyl polymer. That is, the vinyl polymer preferably has a monomer unit made up of a (meth)acrylic acid. For instance the vinyl polymer may include a poly(meth)acrylic acid.

In a case where the crosslinked structure of the amorphous resin A has the above structure, the resulting crosslinking points can form strong covalent bonds. Therefore, the molecular mobility at the crosslinking points of the amorphous resin A does not increase, and the crystalline polyester C that is crystallizing with phase separation from the amorphous resin A can be prevented from exuding from the toner, at the time of piling on the paper output tray after passage through the fixing nip. As a result, the crystalline polyester is supported on the fixed image, and a crystalline polyester layer can be formed without flowing down onto the paper surface, such that yet better abrasion resistance can be achieved.

Preferably, the weight-average molecular weight MwAP of the polyester in the amorphous resin A as measured from a tetrahydrofuran-soluble fraction (THF-soluble fraction) of the polyester satisfies Expression (6) below.

$$3000 \leq MwAP \leq 8000 \qquad ( 6 )$$

When MwAP lies within the above range, this signifies that the polyester is crosslinked, given the of the weight-average molecular weight of the above amorphous resin A. As a result the molecular mobility at the crosslinking points of the amorphous resin A does not increase, and the crystalline polyester C that is crystallizing with phase separation from the amorphous resin A can be prevented from exuding from the toner, at the time of piling on the paper output tray after passage through the fixing nip. Therefore, the crystalline polyester C is supported on dots, and a crystalline polyester layer can be formed without flowing down onto the paper surface, such that yet better abrasion resistance can be achieved.

The fact that MwAP lies within the above range signifies that the molecular weight of the polyester is not too high, and accordingly yet better low-temperature fixability can be achieved. Herein MwAP is more preferably 4000 to 7500, yet more preferably 5000 to 7000.

More preferably, MwAP and MwA satisfy the relationship of Expression (8), from the viewpoint of abrasion resistance. Yet more preferably, MwA/MwAP is 2.7 to 4.0.

$$2.5 \leq MwA / MwAP \leq 6.0 \qquad ( 8 )$$

Preferably, the polyester in the amorphous resin A is a block copolymer having an amorphous polyester segment A1 and an amorphous polyester segment A2. Preferably, only the amorphous polyester segment A1 has a structure corresponding to the straight-chain aliphatic polyhydric alcohol (a). Similarly to the above-described straight-chain aliphatic polyhydric alcohol (c), the structure corresponding to the straight-chain aliphatic polyhydric alcohol (a) is a structure, in the polyester, resulting from condensation of the straight-chain aliphatic polyhydric alcohol (a).

The straight-chain aliphatic polyhydric alcohol (a) is densely present in a case where the amorphous resin A is the above block copolymer. As a result, the above-described crystalline polyester C having a high degree of crystallinity enters the molecular chains of the amorphous resin A via a locally present high-affinity structure corresponding to the straight-chain aliphatic polyhydric alcohol (a), and inter-dissolves readily with the amorphous resin A, thus bringing about a plasticizing effect as a result of which yet better low-temperature fixability can be achieved.

By contrast, the vinyl polymer which is the crosslinked portion inter-dissolves less readily with the crystalline polyester C. In consequence, the molecular mobility at the crosslinking points of the amorphous resin A does not increase, and the crystalline polyester C that is crystallizing with phase separation from the amorphous resin A can be prevented from exuding from the toner, at the time of piling on the paper output tray after passage through the fixing nip. Therefore, the crystalline polyester C does not flow down onto the paper surface, but can be supported on the fixed image, which results in in yet better abrasion resistance.

Herein SPA1 denotes the SP value (J/cm³)^{0.5} of the amorphous polyester segment A1 and SPA2 denotes the SP value (J/cm³)^{0.5} of the amorphous polyester segment A2. Further, SPC denotes the SP value (J/cm³)^{0.5} of the crystalline polyester C. Preferably, SPA1 and SPA2 satisfy Expression (7) below, and SPA and SPC satisfy Expression (9) below.

$$0.8 \leq SPA 1 - SPA 2 \leq 2.5 \qquad ( 7 )$$

$$0.7 \leq SPA - SPC \leq 2.0 \qquad ( 9 )$$

In a case where SPA1-SPA2 lies within the above range, the blockiness of the amorphous resin A becomes manifest, in that the structure corresponding to the straight-chain aliphatic polyhydric alcohol (a) is present more densely. In consequence, the above crystalline polyester C having a high degree of crystallinity enters the molecular chains of the amorphous resin A via the structure corresponding to the straight-chain aliphatic polyhydric alcohol (a), and inter-dissolves readily with the amorphous resin A, such that a yet more pronounced plasticizing effect is brought out thanks to which yet better low-temperature fixability can be achieved.

By contrast, the vinyl polymer which is the crosslinked portion inter-dissolves less readily with the crystalline polyester C. As a result, the molecular mobility at the crosslinking points of the amorphous resin A does not increase, and the crystalline polyester C that is crystallizing with phase separation from the amorphous resin A can be prevented from exuding from the toner, at the time of piling on the paper output tray after passage through the fixing nip. Therefore, the crystalline polyester C does not flow down onto the paper surface, but can be supported on the fixed image, which results in in yet better abrasion resistance.

More preferably, SPA1-SPA2 is 0.9 to 2.0.

More preferably, SPA and SPC satisfy Expression (10) below, from the viewpoint of abrasion resistance.

$$0.8 \leq SPA - SPC \leq 1. \qquad ( 10 )$$

Preferably, the amorphous resin A is a main component of the binder resin. The term “main component” signifies that the content of that component is 50 mass % or higher. The content ratio of the amorphous resin A in the binder resin is preferably from 80.0 mass % to 97.0 mass %, more preferably from 85.0 mass % to 95.0 mass %, and yet more preferably from 86.0 mass % to 90.0 mass %.

A proportion Ws (mass %) of the tetrahydrofuran-soluble fraction of the amorphous resin A referred to the mass of the amorphous resin A satisfies Expression (8) below.

$$9 0. \leq Ws \leq 100.0 \qquad ( 8 )$$

When Ws lies within the above range, this arguably signifies that the weight-average molecular weight does not rise through local crosslinking of the amorphous resin A, which exhibits thus uniform crosslinking. As a result, the molecular mobility at the crosslinking points of the amorphous resin A does not increase, and the crystalline polyester C that is crystallizing with phase separation from the amorphous resin A can be prevented from exuding from the toner, at the time of piling on the paper output tray after passage through the fixing nip. Therefore, the crystalline polyester C is supported on the fixed image, and a crystalline polyester layer can be formed without the crystalline polyester C flowing down onto the paper surface, such that yet better abrasion resistance can be achieved as a result. More preferably, Ws is 95.0 to 100.0 mass %, and yet more preferably 98.0 to 100.0 mass %.

### Amorphous Resin A

The amorphous resin A has a structure in which a polyester is crosslinked with a vinyl polymer.

Preferably, the polyester is a condensation polymer of a polyhydric alcohol (dihydric, trihydric or higher alcohol), and a polyvalent carboxylic acid (divalent, trivalent or higher carboxylic acid), or an acid anhydride thereof or a lower alkyl ester thereof. Among the foregoing, the polyester is more preferably a condensation polymer of a dihydric alcohol and a divalent carboxylic acid, given that the crosslinked structure is formed of vinyl polymer units.

The following polyhydric alcohol monomers can be used as the polyhydric alcohol monomer used for the polyester.

Examples of dihydric alcohol components include ethylene glycol, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, hydrogenated bisphenol A, and bisphenols represented by a formula (A) and derivatives thereof.

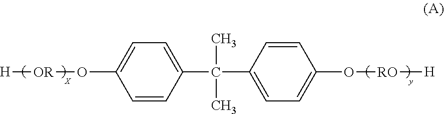

(In the formula (A), R represents an ethylene group or a propylene group, x and y are each an integer of 0 or more, and the average value of x+y is from 0 to 10.)

And the examples includes the diols represented by a formula (B).

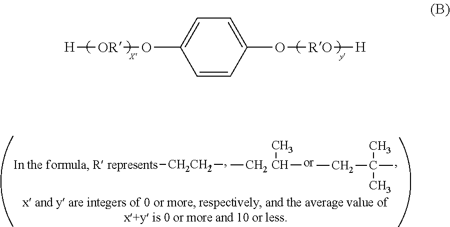

Examples of trihydric or higher alcohol components include sorbitol, 1,2,3,6-hexanetetrol, 1,4-sorbitan, pentaerythritol, dipentaerythritol, tripentaerythritol, 1,2,4-butanetriol, 1,2,5-pentantriol, glycerol, 2-methylpropanetriol, 2-methyl-1,2,4-butanetriol, trimethylolethane, trimethylolpropane, and 1,3,5-trihydroxymethylbenzene. Of these, glycerol, trimethylolpropane, and pentaerythritol are preferably used. These divalent alcohols and trihydric or higher alcohols can be used alone or in combination of two or more.

As the polyvalent carboxylic acid monomer to be used for the polyester, the following polyvalent carboxylic acid monomers can be used.

Examples of divalent carboxylic acid components include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenyl succinic acid, isododecenyl succinic acid, n-dodecyl succinic acid, isododecyl succinic acid, n-octenyl succinic acid, n-octyl succinic acid, isooctenyl succinic acid, isooctyl succinic acid, anhydrides of these acids and lower alkyl esters thereof. Of these, maleic acid, fumaric acid, terephthalic acid, and n-dodecenyl succinic acid are preferably used.

Examples of trivalent or higher carboxylic acids, acid anhydrides thereof or lower alkyl esters thereof include 1,2,4-benzenetricarboxylic acid, 2,5,7-naphthalentricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, Empol trimer acid, acid anhydrides thereof or lower alkyl esters thereof.

Of these, 1,2,4-benzenetricarboxylic acid, that is, trimellitic acid or a derivative thereof, is preferably used because such acid is inexpensive and reaction control thereof is easy. These divalent carboxylic acids and the like and trivalent or higher carboxylic acids can be used alone or in combination of two or more.

Among the foregoing, as pointed out above, the alcohol component preferably has the straight-chain aliphatic polyhydric alcohol (a) having Ca 2 to 10, and more preferably the alcohol component includes ethylene glycol, from the viewpoint of affinity to the straight-chain aliphatic polyhydric alcohol (c). In a case where the straight-chain aliphatic polyhydric alcohol (a) is ethylene glycol, the amorphous resin A has a monomer unit that exhibits high affinity to the crystalline polyester C. In consequence, the above crystalline polyester C having a high crystallization rate can inter-dissolve with the amorphous resin A at the time of fixing nipping, and yet better low-temperature fixability can be achieved as a result.

The amorphous polyester segment A1 preferably contains 10 to 35 mass %, and more preferably 15 to 25 mass %, of the structure corresponding to the straight-chain aliphatic polyhydric alcohol (a) having Ca 2 to 10. The polyester in the amorphous resin A preferably contains from 1 to 10 mass %, and more preferably 1 to 5 mass %, of the structure corresponding to the straight-chain aliphatic polyhydric alcohol (a) having Ca 2 to 10

When the amount of the structure corresponding to the straight-chain aliphatic polyhydric alcohol (a) lies within the above range, the amorphous resin A has a monomer unit that exhibits high affinity to the crystalline polyester C. In consequence, the above crystalline polyester C having a high crystallization rate can inter-dissolve with the amorphous resin A at the time of fixing nipping, and yet better low-temperature fixability can be achieved as a result.

A method for producing the polyester resin is not particularly limited, and a known method can be used. For example, the above-mentioned alcohol monomer and carboxylic acid monomer are simultaneously charged and polymerized through an esterification reaction or a transesterification reaction and a condensation reaction to produce a polyester. In addition, the polymerization temperature is not particularly limited and is preferably in a range of 180 to 290° C. When the polyester is polymerized, polymerization catalysts, for example, titanium-based catalysts, tin-based catalysts, zinc acetate, antimony trioxide, and germanium dioxide can be used.

In particular, the polyester of the amorphous resin A is more preferably a polyester resulting from polymerization using a tin-based catalyst.

A softening point TA of the amorphous resin A is preferably 100.0 to 120.0° C., more preferably 104.0 to 110.0° C.

As pointed out above, the polyester of the amorphous resin A is preferably a block copolymer having the amorphous polyester segment A1 and the amorphous polyester segment A2.

The monomers used for the amorphous polyester segment A1 and the amorphous polyester segment A2 include the above-listed polyhydric alcohols (divalent, trivalent or higher alcohols) and polyvalent carboxylic acids (divalent, trivalent or higher carboxylic acids), or acid anhydrides thereof or lower alkyl esters thereof. Among them, as shown above, it is preferable that only the amorphous polyester segment A1 has a structure corresponding to the straight-chain aliphatic polyhydric alcohol (a) having a Ca of 2 to 10, and it is more preferable that the amorphous polyester segment A1 includes a structure corresponding to ethylene glycol from the viewpoint of affinity with the straight-chain aliphatic polyhydric alcohol (c).

The amorphous polyester segment A1 is preferably a condensation polymer of terephthalic acid and a straight-chain aliphatic polyhydric alcohol (a) having Ca lying in the above range. The amorphous polyester segment A2 is preferably a condensation polymer of a monomer mixture containing terephthalic acid and a bisphenol represented by Formula (A).

The content of the amorphous polyester segment A1 in the amorphous resin A is preferably 1 to 20 mass %, more preferably 5 to 12 mass %. The content of the amorphous polyester segment A2 in the amorphous resin A is preferably 80 to 98 mass %, more preferably 85 to 95 mass %.

The method for eliciting block copolymerization of the amorphous polyester segment A1 and the amorphous polyester segment A2 is not particularly limited, and can be selected as appropriate depending on the intended purpose; examples include the methods in (1) through (3) below, but from the viewpoint of degree of freedom in molecular design, the method is preferably that in (1) or (3), and more preferably that in (1) described below.

(1) Method in which an amorphous polyester segment A1 prepared beforehand as a result of a polymerization reaction and an amorphous polyester segment A2 prepared beforehand as a result of a polymerization reaction are dissolved or dispersed in an appropriate solvent, and are then copolymerized. Herein there may be used, as needed, an extender having two or more functional groups, such as a carboxy group, an isocyanate group, an epoxy group or a carbodiimide group, that react with the hydroxyl group at the terminus of the polymer chain.

(2) Method in which an amorphous polyester segment A1 prepared beforehand as a result of a polymerization reaction and an amorphous polyester segment A2 prepared beforehand as a result of a polymerization reaction are charged into a twin-screw extruder, along with a transesterification catalyst or the like, whereupon a copolymer is prepared in accordance with a reaction extrusion method using a twin-screw extruder or the like.

(3) Copolymerization method in which the hydroxyl groups of an amorphous polyester segment A1 having been prepared beforehand as a result of a polymerization reaction are used as a polymerization initiation component, and copolymerization is accomplished through ring-opening copolymerization of an amorphous polyester segment A2 from a polymer chain terminus of the amorphous polyester segment A1.

The content ratio of the structure crosslinked with a vinyl polymer in the amorphous resin A is preferably 0.1 to 6.0 mass %, more preferably 1.5 to 3.0 mass %.

The method for producing the amorphous resin A having a structure in which a polyester is crosslinked with a vinyl polymer include, although not particularly limited to, the methods set out below.
(i) Production method that involves conducting a transesterification reaction between a polyester component and a polymer that contains a monomer component having an ester group, such as an acrylate ester or a methacrylate ester.
(ii) Production method that involves conducting an esterification reaction between a polyester component and a polymer containing a monomer component having a carboxylic acid group, such as acrylic acid or methacrylic acid.
(iii) Production method that involves polymerizing monomer components that make up a styrene-acrylic copolymer segment, in the presence of a polyester segment containing a monomer component that has an unsaturated bond, such as fumaric acid.

Among the foregoing, the production methods in (i) and (ii) allow constructing a network structure through crosslinking of the termini of polyester units, by virtue of which the mobility of polyester units in the plasticized main chain can be increased, which turn allows achieving excellent low-temperature fixability.

Examples of monomers used in the vinyl polymer as a crosslinking segment include the following.

Styrene derivatives such as o-methylstyrene, m-methylstyrene, p-methylstyrene, p-methoxystyrene and p-phenylstyrene; α-methylene aliphatic monocarboxylic acid esters such as methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate and diethylaminoethyl methacrylate; acrylic acid esters such as methyl acrylate, ethyl acrylate, n-butyl acrylate, isobutyl acrylate, propyl acrylate, n-octyl acrylate, dodecyl acrylate, 2-ethylhexyl acrylate, stearyl acrylate, 2-chloroethyl acrylate, and phenyl acrylate; as well as unsaturated carboxylic acids such as acrylic acid and methacrylic acid.

In addition, as the binder resin, as long as the above effect is not impaired, in addition to the crystalline polyester C and the amorphous resin A, various resin compounds known as the binder resin can be used together. Examples of such resin compounds include a phenolic resin, natural resin-modified phenolic resin, natural resin-modified maleic resin, acrylic resin, methacrylic resin, polyvinyl acetate resin, silicone resin, polyester resin, polyurethane, polyamide resin, furan resin, epoxy resin, xylene resin, polyvinyl butyral, terpene resin, coumarone-indene resin, and petroleum resin.

### Crystalline Polyester C

As the monomer used in the crystalline polyester C, a polyhydric alcohol (alcohols of divalent or trivalent or higher), a polycarboxylic acid (carboxylic acids of divalent or trivalent or higher), and an acid anhydride or lower alkyl ester thereof are used. The crystalline polyester C is preferably a condensation polymer of an aliphatic dicarboxylic acid and an aliphatic diol.

As the polyhydric alcohol monomer used in the crystalline polyester C, the following polyhydric alcohol monomers can be used. The polyhydric alcohol monomer is not particularly limited, and is preferably a chain (more preferably, a linear) aliphatic diol, and examples thereof include ethylene glycol, diethylene glycol, triethylene glycol, 1,2-propylene glycol, 1,3-propylene glycol, dipropylene glycol, 1,4-butanediol, 1,4-butadiene glycol, trimethylene glycol, tetramethylene glycol, pentamethylene glycol, hexamethylene glycol, octamethylene glycol, nonamethylene glycol, decamethylene glycol, and neopentyl glycol. Among these, particularly, linear aliphatics such as ethylene glycol, diethylene glycol, 1,4-butanediol, and 1,6-hexanediol, and α,ω-diol are preferably exemplified.

Polyhydric alcohol monomers other than the above polyhydric alcohol can be used. Among the polyhydric alcohol monomers, examples of divalent alcohol monomers include aromatic alcohols such as polyoxyethylenated bisphenol A and polyoxypropylenated bisphenol A; and 1,4-cyclohexanedimethanol. In addition, among the polyhydric alcohol monomers, examples of polyhydric alcohol monomers of trivalent or higher include aromatic alcohols such as 1,3,5-trihydroxymethylbenzene; and aliphatic alcohols such as pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane, and trimethylolpropane.

As the polycarboxylic acid monomer used in the crystalline polyester C, the following polycarboxylic acid monomers can be used. The polycarboxylic acid monomer is not particularly limited, and is preferably a chain (more preferably, linear) aliphatic dicarboxylic acid.

Specific examples include oxalic acid, malonic acid, succinic acid, glutaric acid, adipic acid, pimelic acid, suberic acid, glutaconic acid, azelaic acid, sebacic acid, nonanedicarboxylic acid, decanedicarboxylic acid, undecanedicarboxylic acid, dodecane dicarboxylic acid, maleic acid, fumaric acid, mesaconic acid, citraconic acid, and itaconic acid, and hydrolyzed acid anhydrides or lower alkyl esters thereof.

A polycarboxylic acid other than the above polycarboxylic acid monomers can be used. Among other polycarboxylic acid monomers, examples of divalent carboxylic acids include aromatic carboxylic acids such as isophthalic acid and terephthalic acid; aliphatic carboxylic acids such as n-dodecyl succinic acid and n-dodecenyl succinic acid; and alicyclic carboxylic acids such as cyclohexanedicarboxylic acid, and also include acid anhydrides or lower alkyl esters thereof.

In addition, among other carboxylic acid monomers, examples of polycarboxylic acids of trivalent or higher include aromatic carboxylic acids such as 1,2,4-benzenetricarboxylic acid (trimellitic acid), 2,5,7-naphthalenetricarboxylic acid, 1,2,4-naphthalenetricarboxylic acid, and pyromellitic acid, and aliphatic carboxylic acids such as 1,2,4-butanetricarboxylic acid, 1,2,5-hexanetricarboxylic acid, and 1,3-dicarboxyl-2-methyl-2-methylenecarboxypropane, and also include derivatives of acid anhydrides or lower alkyl esters thereof.

As pointed out above, among the foregoing, the alcohol component has preferably a straight-chain aliphatic polyhydric alcohol (c) having Cc 2 to 6, and more preferably the alcohol component includes ethylene glycol, in terms of affinity to the straight-chain aliphatic polyhydric alcohol (a) and from the viewpoint of intermolecular cohesion. In a case where the straight-chain aliphatic polyhydric alcohol (c) is ethylene glycol, the intermolecular cohesion of the crystalline polyester C increases, molecular folding is promoted, and crystallization occurs in a short time from after passage through the fixing nip until piling on the paper output tray. As a result there is readily achieved an effect of lowering the friction coefficient, and yet better abrasion resistance is achieved.

The crystalline polyester C is a condensation polymer of a monomer mixture containing a straight-chain aliphatic polyhydric alcohol (c) the Cc whereof lies in the above range and a straight-chain aliphatic diol having a carbon number of 6 to 22 (preferably of 8 to 18). The monomer mixture may contain at least one selected from the group consisting of aliphatic monocarboxylic acids and aliphatic monoalcohols used for the above terminal modification. The total content ratio of the structure resulting from condensation of the aliphatic monocarboxylic acid plus the structure resulting from condensation of the aliphatic monoalcohol, at the termini or the crystalline polyester C, is preferably 3 to 22 mass %, and more preferably 5 to 15 mass %.

The weight-average molecular weight Mwc of the crystalline polyester C is preferably 15000 to 80000, more preferably 15000 to 50000, and yet more preferably 15000 to 25000. When the weight-average molecular weight of the crystalline polyester C lies in the above range, the relationship between the molecular mobility of the amorphous resin A and the viscosity of the crystalline polyester C upon melting is controlled more properly. As a result, the crystalline polyester C becomes readily supported on the fixed image, and a crystalline polyester layer can be formed without the crystalline polyester C flowing down onto the paper surface; accordingly, yet higher abrasion resistance can be obtained as a result.

The total of the acid value plus hydroxyl value of the crystalline polyester C is preferably 0.1 mgKOH/g to 5.0 mgKOH/g. A total of the acid value plus the hydroxyl value of the crystalline polyester C lying in the above range signifies that the crystalline polyester C is a modified crystalline polyester, such that the main chain termini act as a crystal nucleating agent, as described above, thus promoting main chain folding. In consequence, the crystallization rate of the crystalline polyester C becomes higher, and as a result a more pronounced effect of lowering the friction coefficient can be elicited, and yet better abrasion resistance can be achieved.

The crystalline polyester C can be produced according to a general polyester synthesis method. For example, the above carboxylic acid monomers and alcohol monomers are subjected to an esterification reaction or a transesterification reaction, and then subjected to a polycondensation reaction according to a general method under a reduced pressure or by introducing nitrogen gas, and thereby a crystalline polyester C can be obtained. Then, a desired crystalline polyester C can be obtained by additionally adding the above aliphatic compound and performing an esterification reaction.

The esterification or transesterification reaction can be performed using a general esterification catalyst or transesterification catalyst such as sulfuric acid, titanium butoxide, dibutyltin oxide, manganese acetate, or magnesium acetate as necessary.

In addition, the polycondensation reaction can be performed using a general polymerization catalyst, for example, a known catalyst such as titanium butoxide, dibutyltin oxide, tin acetate, zinc acetate, tin disulfide, antimony trioxide, or germanium dioxide. The polymerization temperature and the amount of the catalyst are not particularly limited and may be appropriately determined.

In the esterification or transesterification reaction or polycondensation reaction, methods in which, in order to increase the strength of the crystalline polyester C to be obtained, all of the monomers are added together and in order to reduce the amount of low-molecular-weight components, divalent monomers are reacted first, and monomers of trivalent or higher are then added and reacted may be used.

### Wax

The toner particle may comprises a wax. Examples of waxes include the following waxes.

Hydrocarbon-based waxes such as a low-molecular-weight polyethylene, low-molecular-weight polypropylene, alkylene copolymers, microcrystalline wax, paraffin wax, and Fischer-Tropsch wax; oxides of hydrocarbon-based wax such as oxidized polyethylene wax or block copolymers thereof; waxes mainly composed of fatty acid esters such as carnauba wax; and partially or completely deoxidized fatty acid esters such as deoxidized carnauba wax. Saturated straight-chain fatty acids such as palmitic acid, stearic acid, and montanic acid; unsaturated fatty acids such as brassidic acid, eleostearic acid, and parinaric acid; saturated alcohols such as stearyl alcohol, aralkyl alcohol, behenyl alcohol, carnauba alcohol, ceryl alcohol, and myricyl alcohol; polyhydric alcohols such as sorbitol; esters of fatty acids such as palmitic acid, stearic acid, behenic acid, and montanic acid and alcohols such as stearyl alcohol, aralkyl alcohol, behenyl alcohol, carnauba alcohol, ceryl alcohol, and myricyl alcohol; fatty acid amides such as linoleic acid amide, oleic acid amide, and lauric acid amide; saturated fatty acid bisamides such as methylenebis stearic acid amide, ethylenebiscapric acid amide, ethylenebislauric acid amide, and hexamethylenebis stearic acid amide; unsaturated fatty acid amides such as ethylenebisoleic acid amide, hexamethylenebisoleic acid amide, N,N′-dioleyladipic acid amide, and N,N′-dioleylsebacic acid amide; aromatic bisamides such as m-xylene bisstearic acid amide, and N,N′distearyl isophthalic acid amide; fatty acid metal salts (generally called metal soap) such as calcium stearate, calcium laurate, stearic acidzinc, and magnesium stearate; waxes obtained by grafting vinyl monomers such as styrene and acrylic acid to aliphatic hydrocarbon-based waxes; partially esterified products of fatty acids and polyhydric alcohols such as behenic acid monoglyceride; and methyl ester compounds having a hydroxyl group obtained by hydrogenation of vegetable oils and fats.

Among these waxes, hydrocarbon waxes such as a paraffin wax and Fischer-Tropsch wax are preferable in consideration of reducing blooming. That is, the wax preferably comprises a hydrocarbon wax. The wax is more preferably a Fischer-Tropsch wax.

In order to reduce blooming, the content of the wax with respect to 100 parts by mass of the binder resin is preferably 2 to 10 parts by mass, and more preferably 3 to 8 parts by mass.

The melting point of the wax is preferably from 60 to 120° C. and more preferably from 90 to 110° C.

### Colorant

The toner particle may comprise a colorant as necessary. Examples of the colorant include the following. Examples of black colorant include carbon black and those colored black using a yellow colorant, a magenta colorant, and a cyan colorant. As the colorant, a pigment may be used alone or a dye and a pigment may be used in combination. In consideration of image quality of full color images, it is preferable to use a dye and a pigment in combination.

Pigments for magenta toners can be exemplified by the following: C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, and 282; C. I. Pigment Violet 19; and C. I. Vat Red 1, 2, 10, 13, 15, 23, 29, and 35.

Dyes for magenta toners can be exemplified by the following: oil-soluble dyes such as C. I. Solvent Red 1, 3, 8, 23, 24, 25, 27, 30, 49, 81, 82, 83, 84, 100, 109, and 121; C. I. Disperse Red 9; C. I. Solvent Violet 8, 13, 14, 21, and 27; and C. I. Disperse Violet 1, and basic dyes such as C. I. Basic Red 1, 2, 9, 12, 13, 14, 15, 17, 18, 22, 23, 24, 27, 29, 32, 34, 35, 36, 37, 38, 39, and 40 and C. I. Basic Violet 1, 3, 7, 10, 14, 15, 21, 25, 26, 27, and 28.

Pigments for cyan toners can be exemplified by the following: C. I. Pigment Blue 2, 3, 15:2, 15:3, 15:4, 16, and 17; C. I. Vat Blue 6; C. I. Acid Blue 45; and copper phthalocyanine pigments having at least 1 and not more than 5 phthalimidomethyl groups substituted on the phthalocyanine skeleton. C. I. Solvent Blue 70 is an example of a dye for cyan toners.

Pigments for yellow toners can be exemplified by the following: C. I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185 and by C. I. Vat Yellow 1, 3, and 20. C. I. Solvent Yellow 162 is an example of a dye for yellow toners.

A single one of these colorants may be used or a mixture may be used and these colorants may also be used in a solid solution state. The colorant is selected in consideration of the hue angle, chroma, lightness, lightfastness, OHP transparency, and dispersibility in toner particles.

The amount of the colorant is preferably from 0.1 to 30.0 parts by mass with respect to 100.0 parts by mass of the binder resin.

### Charge Control Agent

The toner particle may contain a charge control agent as necessary. When the charge control agent is added, it is possible to stabilize charge properties, and it is possible to control the optimal triboelectric charge quantity according to a developing system. As the charge control agent, known agents can be used, and particularly, a metal compound of an aromatic carboxylic acid is preferable because it is colorless, has a high toner charging speed, and can stably maintain a constant charge quantity.

Examples of negative charge control agents include salicylate metal compounds, naphthoate metal compounds, dicarboxylic acid metal compounds, polymer type compounds having sulfonic acid or carboxylic acid in the side chain, polymer type compounds having sulfonate or sulfonate ester in the side chain, polymer type compounds having carboxylate or carboxylate ester in the side chain, boron compounds, urea compounds, silicon compounds, and calixarene.

The charge control agent may be internally added or externally added to the toner particle. The content of the charge control agent with respect to 100 parts by mass of the binder resin is preferably 0.2 to 10.0 parts by mass and more preferably 0.5 to 10.0 parts by mass.

### Inorganic Fine Particle

The toner may contain an inorganic fine particle as necessary in addition to the above silica fine particle. The inorganic fine particle may be internally added to the toner particle or may be mixed with the toner as an external additive. Examples of inorganic fine particles include fine particles such as silica fine particles, titanium oxide fine particles, alumina fine particles and complex oxide fine particles thereof. Among the inorganic fine particles, silica fine particles and titanium oxide fine particles are preferable in order to improve the flowability and uniformize charging. The inorganic fine particles are preferably hydrophobized with a hydrophobic agent such as a silane compound, a silicone oil or a mixture thereof.

In order to improve flowability, the inorganic fine particle as an external additive preferably has a specific surface area of 50 to 400 m²/g. In addition, in order to improve durable stability, the inorganic fine particle as an external additive preferably has a specific surface area of 10 to 50 m²/g. In order to improve both flowability and durable stability, inorganic fine particles having a specific surface area within the above range may be used in combination.

The content of the external additive with respect to 100 parts by mass of the toner particle is preferably 0.1 to 10.0 parts by mass. A known mixer such as a Henschel mixer can be used to mix the toner particle and the external additive.

### Developer

The toner can be used as a one-component developer, and in order to further improve dot reproducibility and in order to supply stable images over a long time, it is preferably mixed with a magnetic carrier and used as a two-component developer.

The toner is preferably a toner for use in a two-component developer. The two-component developer comprises a toner and a magnetic carrier, and the toner is preferably the toner described above.

Examples of the magnetic carrier include generally known magnetic carriers such as magnetic bodies such as iron oxide, metal particles such as iron, lithium, calcium, magnesium, nickel, copper, zinc, cobalt, manganese, chromium, and rare earth, particles of alloys thereof, oxide particles, ferrites, etc., and magnetic body-dispersed resin carriers (the so-called resin carriers) including magnetic bodies and a binder resin in which the magnetic bodies are held in a dispersed state.

When the toner is mixed with a magnetic carrier and used as a two-component developer, the mixing ratio of the magnetic carrier at that time is preferably 2 to 15 mass % and more preferably 4 to 13 mass % or less, as the toner concentration in the two-component developer.

### Method of Producing Toner Particle

The method of producing a toner particle is not particularly limited, and known methods such as a pulverization method, a suspension polymerization method, a dissolution suspension method, an emulsion aggregation method, and a dispersion polymerization method can be used. Among these, the pulverization method is preferable in order to control the wax on the surface of the toner. That is, the toner particle is preferably a pulverized toner particle. Hereinafter, the toner producing procedure in the pulverization method will be described.

The pulverization method includes for instance: a starting material mixing step of mixing the crystalline polyester C and the amorphous resin A, as binder resins, and other components such as a wax, a colorant and a charge control agent, as needed; a step of melting and kneading the resulting starting material mixture, to yield a resin composition; and a step of pulverizing the obtained resin composition, to yield a toner particle.

In the raw material mixing step, for materials constituting the toner particle, for example, predetermined amounts of a binder resin, a wax, and as necessary, other components such as a colorant and a charge control agent, are weighed out and added and mixed. Examples of mixing devices include a double cone mixer, a V-type mixer, a drum type mixer, a super mixer, a Henschel mixer, Nauta Mixer, and Mechano Hybrid (commercially available from Nippon Coke & Engineering. Co., Ltd.).

Next, the mixed materials are melted and kneaded, and the materials are dispersed in the binder resin. In the melt-kneading step, a batch type kneading machine such as a pressure kneader and a Banbury mixer or a continuous type kneading machine can be used, and single-screw or twin-screw extruders are mainstream due to the superiority of continuous production. Examples thereof include KTK type twin-screw extruder (commercially available from Kobelco), TEM type twin-screw extruder (commercially available from Toshiba Machine Co., Ltd.), PCM kneader (commercially available from Ikegai), twin-screw extruder (commercially available from KGK Corporation), Ko-Kneader (commercially available from Buss Corporation), and KNEADEX (commercially available from Nippon Coke & Engineering. Co., Ltd.). In addition, the resin composition obtained by melt-kneading may be rolled with two rollers or the like and cooled with water or the like in the cooling step.

Then, the cooled product of the kneaded product can be pulverized to a desired particle diameter in the pulverization step. In the pulverization step, after coarse pulverization with a pulverizer such as a crusher, a hammer mill, or a feather mill, fine pulverization is further performed, for example, with Cryptron System (manufactured by Kawasaki Heavy Industries, Ltd.), Super Rotor (manufactured by Nisshin Engineering Co., Ltd.), a turbo mill (manufactured by Turbo Industry Co., Ltd.), or a fine pulverizer based on an air jet method.

After that, if necessary, classification is performed with a classifier or a sieving machine such as Elbow Jet of an inertial classification system (manufactured by Nittetsu Mining Co., Ltd.), Turboplex of a centrifugal force classification system (manufactured by Hosokawa Micron Corporation), a TSP separator (manufactured by Hosokawa Micron Corporation), and Faculty (manufactured by Hosokawa Micron Corporation) to obtain toner particles.

Then, as necessary, an external additive such as the silica fine particle is externally added to the surface of the toner particle to obtain a toner. Examples of methods of externally adding an external additive include a method in which predetermined amounts of the classified toner and various known external additives are added and stirred and mixed using a mixing device such as a double cone mixer, a V-type mixer, a drum type mixer, a super mixer, a Henschel mixer, a Nauta Mixer, a Mechano Hybrid (commercially available from Nippon Coke & Engineering. Co., Ltd.), or Nobilta (commercially available from Hosokawa Micron Corporation) as an external addition device.

Methods for measuring various physical properties will be explained next.

Methods for Separating Various Materials from Toner

Materials can be separated from the toner by exploiting differences in solubility, in a given solvent, between materials contained in the toner. The various physical properties below can be measured using the separated materials.

First separation: the toner is dissolved in methyl ethyl ketone (MEK) at 23° C., to separate a soluble fraction (amorphous resin A and crystalline polyester C) and an insoluble fraction (wax, colorant, inorganic fine particles and so forth).

Second separation: the soluble fraction (amorphous resin A, crystalline polyester C) obtained in the first separation is dissolved in tetrahydrofuran (THF) at 23° C., to separate a soluble fraction (amorphous resin A) and an insoluble fraction (crystalline polyester C).

Third separation: the insoluble fraction (wax, colorant, inorganic fine particles and so forth) obtained in the first separation is dissolved in MEK at 100° C., to separate a soluble fraction (wax) and an insoluble fraction (colorant, inorganic fine particles and so forth).

Method for Measuring Attribution and Content Ratios of Monomer Units of Various Polymerizable Monomers in Amorphous Resin A and Crystalline Polyester C

An attribution and a content ratio of the monomer units of the various polymerizable monomers in the amorphous resin A and the crystalline polyester C are measured by ¹H-NMR under the following conditions.
Measurement device: FT NMR device JNM-EX400 (commercially available from JEOL Ltd.)
Measurement frequency: 400 MHz
Pulse condition: 5.0 μs
Frequency range: 10500 Hz
Cumulative number of measurements: 64
Measurement temperature: 30° C.
Sample: 50 mg of a measurement sample is put into a sample tube having an inner diameter of 5 mm, deuterated chloroform (CDCl₃) as a solvent is added, and the mixture is dissolved in a thermostatic tank at 40° C. for preparation.

Using the obtained ¹H-NMR chart, the integrated values S₁, S₂, S₃, . . . Sₙ of the peaks belonging to elements constituting monomer units of various polymerizable monomers are calculated.

The content of monomer units of various polymerizable monomers is obtained as follows using the integrated values S₁, S₂, S₃ and Sₙ. Here, n₁, n₂, n₃ . . . nₙ are the number of hydrogen atoms in constituent elements to which the focused peaks for respective parts belong.

$$Content of monomer units of various polymerizable monomers ( mol \% ) = \{ ( {S}_{n} / {n}_{n} ) / ( ( {S}_{1} / {n}_{1} ) + ( {S}_{2} / {n}_{2} ) + ( {S}_{3} / {n}_{3} ) … + ( {S}_{n} / {n}_{n} ) ) \} \times 100$$

By changing the numerator term in the same operation, the amount of monomer units of various polymerizable monomers is calculated. Here, when a polymerizable monomer that does not contain a hydrogen atom is used in the monomer units of various polymerizable monomers, the atom nucleus to be measured is set to ¹³C using ¹³C-NMR, measurement is performed in a single pulse mode, and calculation is performed in the same manner as with ¹H-NMR.

Method for Calculating the SPA Value, SPA1 Value, SPA2 Value of Amorphous Resin A; SP Values of Amorphous Polyester Segment A1, Amorphous Polyester Segment A2 and Monomer Units by Polymerizable Monomers of Amorphous Resin A; SPC value of Crystalline Polyester C; and SP Values of Monomer Units by Polymerizable Monomers in Crystalline Polyester C

The SP values are determined as follows in accordance with the calculation method proposed by Fedors.

The evaporation energy (Δei) (cal/mol) and molar volume (Δvi) (cm³/mol) of atoms or atomic groups in the molecular structure of the monomer units by respective polymerizable monomers are determined on the basis of the tables given in Polym. Eng. Sci., 14 (2), 147-154 (1974)”, where (ΣΔei/ΣΔvi)^{0.5} is taken as the SP value (cal/cm³)^{0.5}. The units of SP value can be converted by virtue of the fact that 1 (cal/cm³)^{0.5}=2.045 (J/cm³)^{0.5}.

Herein SPA, SPA1, SPA2 and SPC are calculated as follows. Firstly, the evaporation energy (Δei) and molar volume (Δvi) of the monomer units derived from the constituent polymerizable monomers are determined, for each monomer unit, and thereupon there is calculated the product of each monomer unit and the respective molar ratio (j) in the given resin. Then the sum total of the evaporation energies and the sum total of the molar volumes of the respective monomer units are plugged in the expression below, to thereby calculate respective SP values.

$$SP value = {\{ ( \sum j \times \sum Δ ei ) / ( \sum j \times \sum Δ vi ) \}}^{0.5}$$

### Measurement of the Weight-Average Molecular Weight MwC of Crystalline Polyester C by GPC

The weight-average molecular weight (Mw) of the toluene-soluble component of the crystalline polyester C at 100° C. is measured as follows through gel permeation chromatography (GPC).

First, the crystalline polyester C is dissolved in toluene at 100° C. for 1 hour. Then, the obtained solution is filtered through a solvent-resistant membrane filter having a pore diameter of 0.2 μm (“Mysyori Disk” commercially available from Tosoh Corporation) to obtain a sample solution. Here, the sample solution is adjusted so that the concentration of the toluene-soluble component is about 0.1 mass %. Measurement is performed using the sample solution under the following conditions.
Device: HLC-8121GPC/HT (commercially available from Tosoh Corporation)
Column: TSKgel GMHHR-H HT (7.8 cm I. D×30 cm) two columns (commercially available from Tosoh Corporation)
Detector: RI for high temperature
Temperature: 135° C.
Solvent: toluene
Flow rate: 1.0 mL/min
Sample: inject 0.4 mL of 0.1% sample

A molecular weight calibration curve prepared from a monodisperse polystyrene standard sample is used to calculate the molecular weight of the sample. In addition, it is calculated by performing conversion to polyethylene according to a conversion formula derived from the Mark-Houwink viscosity formula.

### Measurement of Melting Peak Temperature (Melting Point) T_{C} (° C.) of Crystalline Polyester C, etc.

The melting point (Tc) of the crystalline polyester C is measured according to ASTM D3418-82 using a differential scanning calorimetry analyzer “Q2000” (commercially available from TA Instruments).

The temperature of the device detector is corrected using the melting points of indium and zinc, and heat of fusion of indium is used to correct the amount of heat. Specifically, 3 mg of the sample is accurately weighed out, put into an aluminum pan, and measured under the following conditions using an empty aluminum pan as a reference.
Ramp rate: 10° C./min
Measurement start temperature: 30° C.
Measurement end temperature: 180° C.

Measurement is performed in a measurement range of 30 to 180° C. at a ramp rate of 10° C./min. The temperature is once raised to 180° C. and the sample is held for 10 minutes, the temperature is then lowered to 30° C., and the temperature is then raised again. The melting point is a temperature at which the endothermic peak of a temperature-endothermic curve is a maximum in a range of 30 to 100° C. in the second heating procedure.

Measurement of the Weight-Average Molecular Weights MwA, MwA1, MwA2 and MwAP of Amorphous Resin A, Amorphous Polyester Segment A1, Amorphous Polyester Segment A2 and Polyester Units by GPC

The Weight-Average Molecular Weight (Mw) of a THF-soluble fraction is measured by gel permeation chromatography (GPC) as follows.

Firstly, the toner is dissolved in tetrahydrofuran (THF) over 24 hours at room temperature. The obtained solution is filtered through a solvent-resistant membrane filter “MYSYORI DISC” (by Tosoh Corporation) having pore diameter of 0.2 m, to yield a sample solution. The sample solution is adjusted so that the concentration of components soluble in THF is 0.8 mass %. A measurement is performed then under the conditions below, using the sample solution.
Device: HLC8120 GPC (detector: RI) (by Tosoh Corporation)
Column: 7 columns Shodex KF-801, 802, 803, 804, 805, 806, 807 (by Showa Denko KK)
Eluent: tetrahydrofuran (THF)
Flow rate: 1.0 ml/min
Oven temperature: 40.0° C.
Sample injection amount: 0.10 mL

To calculate the molecular weight of the sample there is used a molecular weight calibration curve created using a standard polystyrene resin (for instance product name “TSK STANDARD POLYSTYRENE F-850, F-450, F-288, F-128, F-80, F-40, F-20, F-10, F-4, F-2, F-1, A-5000, A-2500, A-1000 or A-500”, by Tosoh Corporation).

### Measurement of the Softening Point TA of Amorphous Resin A

The softening point is measured using a constant-load extrusion type capillary rheometer “Flow Tester CFT-500D” (manufactured by Shimadzu Corporation) according to the manual provided with the device. In this device, while applying a constant-load from the top of the measurement sample with a piston, the temperature of the measurement sample filled in a cylinder is raised, the sample is melted, the melted measurement sample is pushed out from a die at the bottom of the cylinder, and a flow curve showing the relationship between the piston descent amount and temperature at this time can be obtained.

The softening point is the “melting temperature in the ½ method” described in the manual provided with the “flow characteristic evaluation device Flow Tester CFT-500D”. The melting temperature in the ½ method is calculated in the following manner. First, ½ of the difference between the piston descent amount Smax at the time when the outflow ends and the piston descent amount Smin at the time when the outflow starts is obtained (this is denoted by X. X=(Smax−Smin)/2). The temperature at the flow curve when the piston descent amount in the flow curve is the sum of X and Smin is the melting temperature in the ½ method.

A columnar measurement sample with a diameter of about 8 mm is prepared by compression molding about 1.9 g of the resin at about 10 MPa for about 60 sec by using a tablet molding compressor (for example, NT-100H, manufactured by NPA System Co., Ltd.) in an environment of 25° C.

Specific operations in the measurement are performed according to the manual bundled in the device.

The measurement conditions of CFT-500D are as follows.
Test mode: heating method
Starting temperature: 50° C.
Reached temperature: 200° C.
Measurement interval: 1.0° C.
Temperature rise rate: 4.0° C./min
Piston cross-sectional area: 1.000 cm²
Test load (piston load): 10.0 kgf/cm² (0.9807 MPa)
Preheating time: 300 sec
Die hole diameter: 1.0 mm
Die length: 1.0 mm

### Method for Measuring the Proportion Ws of THF-Soluble Fraction of Amorphous Resin A

The proportion Ws of the THF-soluble fraction is measured using a Soxhlet.

Herein 1 g of the sample of the amorphous resin A is weighed exactly, is set on cylindrical filter paper, and is subjected to Soxhlet extraction with 200 ml of tetrahydrofuran (THF) for 20 hours. Thereafter, the cylindrical filter paper is retrieved, and the residue mass after vacuum drying at 40° C. for 20 hours is measured, whereupon the proportion Ws of the THF-soluble fraction of the amorphous resin A is calculated, in accordance with the expression below, on the basis of W1 (g) as the mass of the sample initially introduced and W2 (g) as the mass of the component in the extraction residue.

$$Ws ( mass \% ) = ( W 1 - W 2 ) / W 1 \times 100$$

In a measurement through separation of the amorphous resin A from the toner, Ws is worked out by adding the MEK insoluble fraction to W1.

### EXAMPLES

Hereinafter, the present invention will be described in more detail with reference to examples, but these are not intended to limit the present invention. Here, in the following examples, unless otherwise specified, parts are based on mass.

### Production Example of Crystalline Polyester C1

Ethylene glycol: 9.0 parts (49.2 mol %)
Tetradecanedioic acid: 81.0 parts (48.5 mol %)
Behenic acid: 10.0 parts (2.3 mol %)
Titanium tetrabutoxide (esterification catalyst): 0.5 parts

The above materials were weighed into a reaction tank equipped with a cooling tube, a stirrer, a nitrogen introduction tube and a thermocouple. Next, the interior of the tank was purged with nitrogen gas, and thereafter the temperature was gradually raised while under stirring; the reaction was conducted for 2 hours while under stirring at a temperature of 200° C.

Further, the pressure in the reaction tank was lowered to 8.3 kPa, the reaction was conducted for 5 hours while maintaining the temperature at 200° C., and then the temperature was lowered, to thereby to stop the reaction, and yield Crystalline polyester C1. The obtained Crystalline polyester C1 had a weight-average molecular weight Mw of 18000 and a melting point Tc of 92° C.

An NMR analysis of Crystalline polyester C1 revealed the presence of 49.2 mol % of monomer units derived from ethylene glycol, 48.5 mol % of monomer units derived from tetradecanedioic acid and 2.3 mol % of monomer units derived from behenic acid. The SP value SPC of the Crystalline polyester C1 was 20.0 (J/cm³)^{0.5}.

### Production Examples of Crystalline Polyester C2 to Crystalline Polyester C11

Crystalline polyester C2 to Crystalline polyester C11 were obtained by performing a reaction as in the production example of Crystalline polyester C1, but modifying herein the type and parts by mass of the straight-chain aliphatic polyhydric alcohol (c), the polymerizable monomers, the aliphatic monocarboxylic acid or the aliphatic monoalcohol, as given in Table 1. Table 2 sets out the physical properties of Crystalline polyester C2 to Crystalline polyester C11.

TABLE 1

| | | | | | | | | | Terminal modification | | | |
|---|---|---|---|---|---|---|---|---|---|---|---|---|
| | Straight-chain aliphatic | | | | | | | | Aliphatic monocarboxylic acid | | | |
| Crystalline | polyhydric alcohol (c) | | | | Polymerizable monomer | | | | Aliphatic monoalcohol | | | |
| polyester | Type/ | | | | Type/ | | | | Type/ | | | |
| C | unit | SPc-1 | parts | mol % | unit | SPc-2 | parts | mol % | unit | SPc-3 | parts | mol % |
| 1 | ED | 17.5 | 9.0 | 49.2 | TDA | 20.4 | 81.0 | 48.5 | BEA | 18.5 | 10.0 | 2.3 |
| 2 | ED | 17.5 | 9.0 | 48.9 | TDA | 20.4 | 81.0 | 48.1 | PAA | 18.8 | 10.0 | 3.0 |
| 3 | ED | 17.5 | 9.0 | 48.8 | TDA | 20.4 | 81.0 | 48.1 | PEA | 18.9 | 10.0 | 3.1 |
| 4 | ED | 17.5 | 9.0 | 49.5 | TDA | 20.4 | 81.0 | 48.7 | MOA | 18.3 | 10.0 | 1.8 |
| 5 | ED | 17.5 | 9.0 | 49.6 | TDA | 20.4 | 81.0 | 48.8 | LAA | 18.2 | 10.0 | 1.6 |
| 6 | ED | 17.5 | 9.0 | 48.3 | TDA | 20.4 | 86.0 | 50.6 | BEA | 18.5 | 5.0 | 1.1 |
| 7 | ED | 17.5 | 9.0 | 51.3 | TDA | 20.4 | 70.0 | 43.7 | BEA | 18.5 | 21.0 | 5.0 |
| 8 | HD | 17.5 | 22.0 | 48.3 | TDA | 20.4 | 68.0 | 49.0 | BEA | 18.5 | 10.0 | 2.7 |
| 9 | ED | 17.5 | 9.0 | 48.1 | TDA | 20.4 | 87.0 | 51.0 | BEA | 18.5 | 4.0 | 0.9 |
| 10 | ED | 17.5 | 9.0 | 51.6 | TDA | 20.4 | 69.0 | 43.2 | BEA | 18.5 | 22.0 | 5.2 |
| 11 | OD | 17.5 | 29.0 | 50.5 | TDA | 20.4 | 61.0 | 46.6 | BEA | 18.5 | 10.0 | 2.9 |

The abbreviations in Table 1 are as follows.
ED: Ethanediol (ethylene glycol) (carbon number 2)
HD: Hexanediol (carbon number 6)
OD: Octanediol (carbon number 8)
TDA: Tetradecanedioic acid
BEA: Behenic acid (carbon number 22)
PAA: Palmitic acid (carbon number 16)
PEA: Pentadecanoic acid (carbon number 15)
MOA: Montanic acid (carbon number 28)
LAA: Lacceroic acid (carbon number 32)

TABLE 2

| Crystalline | Physical properties | | |
|---|---|---|---|
| polyester C | SPc | Mwc | Tc |
| 1 | 20.0 | 18000 | 92 |
| 2 | 20.0 | 18000 | 92 |
| 3 | 20.0 | 18000 | 92 |
| 4 | 19.9 | 18000 | 92 |
| 5 | 19.9 | 18000 | 92 |
| 6 | 20.0 | 18000 | 90 |
| 7 | 19.8 | 18000 | 100 |
| 8 | 19.5 | 50000 | 90 |
| 9 | 20.0 | 18000 | 89 |
| 10 | 19.8 | 18000 | 101 |
| 11 | 19.3 | 18000 | 71 |

In the table, the unit of SP value, for instance SPC, is (J/cm³)^{0.5}. Further, Mwc denotes the weight-average molecular weight of the crystalline polyester C. The units of Tc are ° C.

### Production Example of Amorphous Polyester Segment A1-1

Ethylene glycol: 19.0 parts (50.1 mol %)
Terephthalic acid: 81.0 parts (49.9 mol %)
Titanium tetrabutoxide (esterification catalyst): 0.5 parts

The above materials were weighed into a reaction tank equipped with a cooling tube, a stirrer, a nitrogen introduction tube and a thermocouple. Next, the interior of the tank was purged with nitrogen gas, and thereafter the temperature was gradually raised while under stirring; the reaction was conducted for 2 hours while under stirring at a temperature of 200° C.

The pressure in the reaction tank was lowered down to 8.3 kPa, the temperature was maintained at 200° C., and the reaction was allowed to proceed for 5 hours; once the weight-average molecular weight proved to have reached 800, the temperature was lowered to stop the reaction, and yield Amorphous polyester segment A1-1.

An NMR analysis of the above Amorphous polyester segment A1-1 revealed the presence of 50.1 mol % of monomer units derived from ethylene glycol and 49.9 mol % of monomer units derived from terephthalic acid. The SP value of the Amorphous polyester segment A1-1 was calculated in accordance with the above method; herein SP_{A1} was 22.6 (J/cm³)^{0.5}

### Production Examples of Amorphous Polyester Segment A1-2 to Amorphous Polyester Segment A1-5

Amorphous polyester segment A1-2 to Amorphous polyester segment A1-5 were obtained by performing a reaction as in the production example of Amorphous polyester segment A1-1, but modifying herein the type and parts by mass of the straight-chain aliphatic polyhydric alcohol and of the polymerizable monomers as given in Table 3. The physical properties are given in Table 3.

TABLE 3

| | Straight-chain aliphatic | | | | | | | | | |
|---|---|---|---|---|---|---|---|---|---|---|
| Amorphous | polyhydric alcohol (a) | | | | Polymerizable monomer | | | | Physical | |
| polyester | Type/ | | | | Type/ | | | | properties | |
| segment A1 | unit | SPA1-1 | Parts | mol % | unit | SPA1-2 | Parts | mol % | SPA1 | MwA1 |
| A1-1 | ED | 17.5 | 19.0 | 50.1 | TPA | 24.3 | 81.0 | 49.9 | 22.6 | 800 |
| A1-2 | HD | 17.5 | 40.0 | 48.8 | TPA | 24.3 | 60.0 | 51.2 | 21.1 | 800 |
| A1-3 | DD | 17.5 | 54.0 | 50.1 | TPA | 24.3 | 46.0 | 49.9 | 20.1 | 800 |
| A1-4 | OD | 17.5 | 48.0 | 49.7 | TPA | 24.3 | 52.0 | 50.3 | 20.5 | 800 |
| A1-5 | DDD | 17.5 | 59.0 | 50.7 | TPA | 24.3 | 41.0 | 49.3 | 19.8 | 800 |

The abbreviations in Table 3 are as follows.
ED: Ethanediol (ethylene glycol) (carbon number 2)
HD: Hexanediol (carbon number 6)
DD: Decanediol (carbon number 10)
OD: Octanediol (carbon number 8)
DDD: Dodecanediol (carbon number 12)
TPA: Terephthalic acid

Herein SPA1-1 and SPA1-2 are SP values of monomer units of respective polymerizable monomers. Further, MwA1 is the weight-average molecular weight of amorphous polyester segment A1.

### Production Example of Amorphous Polyester Segment A2-1

Propylene oxide adduct of bisphenol A (average number of added moles: 2.0 mol): 72.0 parts (49.9 mol %)
Terephthalic acid: 28.0 parts (50.1 mol %)
Titanium tetrabutoxide (esterification catalyst): 0.5 parts

The above materials were weighed into a reaction tank equipped with a cooling tube, a stirrer, a nitrogen introduction tube and a thermocouple. Next, the interior of the tank was purged with nitrogen gas, and thereafter the temperature was gradually raised while under stirring; the reaction was conducted for 2 hours while under stirring at a temperature of 200° C.

The pressure in the reaction tank was lowered down to 8.3 kPa, the temperature was maintained at 200° C., and the reaction was allowed to proceed for 5 hours; once the weight-average molecular weight proved to have reached 1000, the temperature was lowered to stop the reaction, and yield Amorphous polyester segment A2-1.

An NMR analysis of the above Amorphous polyester segment A2-1 revealed that the presence of 49.9 mol % of monomer units from the propylene oxide adduct of bisphenol A (average number of added moles: 2.0 mol) and 50.1 mol % of monomer units derived from terephthalic acid. The SP value of the Amorphous polyester segment A2-1 was calculated in accordance with the above method; herein SP_{A2} was 20.7 (J/cm³)^{0.5}.

### Production Examples of Amorphous Polyester Segment A2-2 to Amorphous Polyester Segment A2-6

Amorphous polyester segment A2-2 to Amorphous polyester segment A2-6 were obtained by performing a reaction as in the production example of Amorphous polyester segment A2-1, but modifying herein the type and parts by mass of the straight-chain aliphatic polyhydric alcohol and of the polymerizable monomers as given in Table 4. The physical properties are given in Table 4.

TABLE 4

| Amorphous | Polymerizable monomer | | | | Polymerizable monomer | | | | Polymerizable monomer | | | | Physical | |
|---|---|---|---|---|---|---|---|---|---|---|---|---|---|---|
| polyester | Type/ | | | mol | Type/ | | | mol | Type/ | | | mol | properties | |
| segment A2 | unit | SPA2-1 | Parts | % | unit | SPA2-2 | Parts | % | unit | SPA2-3 | Parts | % | SPA2 | MwA2 |
| A2-1 | PO2 | 19.5 | 72.0 | 49.9 | TPA | 24.3 | 28.0 | 50.1 | — | — | — | — | 20.7 | 1000 |
| A2-2 | EO2 | 20.1 | 65.0 | 49.7 | TPA | 24.3 | 20.0 | 35.9 | FA | 42.2 | 15.0 | 14.4 | 21.7 | 1000 |
| A2-3 | EO2 | 20.1 | 65.0 | 54.2 | TPA | 24.3 | 10.0 | 19.6 | FA | 42.2 | 25.0 | 26.2 | 21.9 | 1000 |
| A2-4 | PO2 | 19.5 | 49.0 | 50.2 | TPA | 24.3 | 5.0 | 13.2 | SA | 21.4 | 46.0 | 36.6 | 20.3 | 1000 |
| A2-5 | PO2 | 19.5 | 44.0 | 49.3 | TPA | 24.3 | 1.0 | 2.9 | SA | 21.4 | 55.0 | 47.8 | 20.2 | 1000 |
| A2-6 | PO2 | 19.5 | 63.0 | 49.9 | TPA | 24.3 | 10.0 | 20.5 | FA | 42.2 | 27.0 | 29.6 | 21.5 | 1000 |

The abbreviations in Table 4 are as follows.
PO2: Propylene oxide adduct of bisphenol A (average number of added moles: 2.0 mol);
EO2: Ethylene oxide adduct of bisphenol A (average number of added moles: 2.0 mol)
TPA: Terephthalic acid
FA: Fumaric acid
SA: Sebacic acid
SPA2-1, SPA2-2, and SPA2-3 are SP values of monomer units of respective polymerizable monomers. MwA2 is the weight-average molecular weight of amorphous polyester segment A2.

### Production Example of Amorphous Resin A-1

Amorphous polyester segment A1-1: 8.0 parts (8.1 mol %)
Amorphous polyester segment A2-1: 90.0 parts (73.0 mol %)
Titanium tetrabutoxide (esterification catalyst): 0.5 parts

The above materials were weighed into a reaction tank equipped with a cooling tube, a stirrer, a nitrogen introduction tube and a thermocouple. Next, the interior of the tank was purged with nitrogen gas, and thereafter the temperature was gradually raised while under stirring; the reaction was conducted for 2 hours while under stirring at a temperature of 200° C.

The pressure in the reaction tank was lowered down to 8.3 kPa, the temperature was maintained at 200° C., and the reaction was allowed to proceed for 5 hours; once the weight-average molecular weight proved to have reached 6000, the following materials were added. Then the reaction was allowed to proceed for 2 hours, and once the softening point proved to have reached 106° C. in a measurement according to ASTM D36-86, the temperature was lowered to stop the reaction, and yield Amorphous resin A-1.
Methacrylic acid: 2.0 parts (18.9 mol %)
t-butyl peroxypivalate (by NOF Corporation: Perbutyl PV): 0.5 parts

The softening point TA of the obtained Amorphous resin A-1 was 106° C., the weight-average molecular weight MwA of Amorphous resin A-1 was 18000, the weight-average molecular weight MwAP of the polyester units was 6000, the proportion Ws of the THF-soluble fraction was 100.0 mass %, and SPA1-SPA2 was 1.9.

An NMR analysis of the Amorphous resin A-1 revealed the presence of 8.1 mol % of segments derived from the Amorphous polyester segment A1-1, 73.0 mol % of segments derived from Amorphous polyester segment A2-1 and 18.9 mol % of monomer units derived from methacrylic acid. The SP value of Amorphous resin A-1 was calculated in accordance with the above method; herein SPA was 20.8 (J/cm³)^{0.5}.

Production Examples of Amorphous Resin A-2 to Amorphous Resin A-7, Amorphous Resin A-9 to Amorphous Resin A-17, and Amorphous Resin A-27 to Amorphous Resin A-31

Amorphous resin A-2 to Amorphous resin A-7, Amorphous resin A-9 to Amorphous resin A-17, Amorphous resin A-27 to Amorphous resin A-31 were obtained by performing a reaction as in the production example of Amorphous resin A-1, but modifying herein the type and parts by mass of polymerizable monomers of the amorphous polyester segment A1 and the amorphous polyester segment A2, as given in Table 5. The physical properties are given in Table 6. Amorphous resin A29 that utilizes trimellitic acid does not have a structure in which a polyester is crosslinked with a vinyl polymer.

TABLE 5

| | Amorphous polyester | | | Amorphous polyester | | | Polymerizable | | |
|---|---|---|---|---|---|---|---|---|---|
| Amorphous | segment A1 | | | segment A2 | | | monomer | | |
| resin A | Type | Parts | mol % | Type | Parts | mol % | Type | Parts | mol % |
| 1 | A1-1 | 8.0 | 8.1 | A2-1 | 90.0 | 73.0 | MA | 2.0 | 18.9 |
| 2 | A1-1 | 8.0 | 8.5 | A2-1 | 90.0 | 76.5 | HA | 2.0 | 15.0 |
| 3 | A1-1 | 8.0 | 8.8 | A2-1 | 90.0 | 78.8 | OA | 2.0 | 12.4 |
| 4 | A1-1 | 7.0 | 7.1 | A2-2 | 91.0 | 74.0 | MA | 2.0 | 18.9 |
| 5 | A1-1 | 7.0 | 7.1 | A2-3 | 91.0 | 74.0 | MA | 2.0 | 18.9 |
| 6 | A1-1 | 5.0 | 5.1 | A2-4 | 93.0 | 75.9 | MA | 2.0 | 19.0 |
| 7 | A1-1 | 5.0 | 5.1 | A2-5 | 93.0 | 75.9 | MA | 2.0 | 19.0 |
| 8 | Set out in separate table | | | | | | | | |
| 9 | A1-1 | 8.0 | 7.5 | A2-1 | 89.0 | 66.5 | MA | 3.0 | 26.0 |
| 10 | A1-1 | 8.0 | 7.4 | A2-1 | 88.9 | 65.9 | MA | 3.1 | 26.7 |
| 11 | A1-1 | 8.0 | 9.3 | A2-1 | 91.5 | 85.3 | MA | 0.5 | 5.4 |
| 12 | A1-1 | 8.0 | 9.4 | A2-1 | 91.6 | 86.2 | MA | 0.4 | 4.4 |
| 13 | A1-1 | 8.0 | 8.4 | A2-6 | 90.0 | 75.5 | ST | 2.0 | 16.1 |
| 14 | A1-1 | 8.0 | 9.6 | A2-1 | 91.8 | 88.2 | MA | 0.2 | 2.2 |
| 15 | A1-1 | 8.0 | 6.5 | A2-1 | 87.0 | 56.1 | MA | 5.0 | 37.4 |
| 16 | A1-2 | 8.0 | 8.1 | A2-1 | 90.0 | 73.0 | MA | 2.0 | 18.9 |
| 17 | A1-3 | 8.0 | 8.1 | A2-1 | 90.0 | 73.0 | MA | 2.0 | 18.9 |
| 18 | Set out in separate table | | | | | | | | |
| 19 | Set out in separate table | | | | | | | | |
| 20 | Set out in separate table | | | | | | | | |
| 21 | Set out in separate table | | | | | | | | |
| 22 | Set out in separate table | | | | | | | | |
| 23 | Set out in separate table | | | | | | | | |
| 24 | Set out in separate table | | | | | | | | |
| 25 | Set out in separate table | | | | | | | | |
| 26 | Set out in separate table | | | | | | | | |
| 27 | A1-1 | 8.0 | 9.7 | A2-1 | 91.9 | 89.2 | MA | 0.1 | 1.1 |
| 28 | A1-1 | 8.0 | 6.4 | A2-1 | 86.9 | 55.7 | MA | 5.1 | 37.9 |
| 29 | A1-1 | 8.0 | 8.6 | A2-1 | 84.0 | 72.2 | TA | 8.0 | 19.2 |
| 30 | A1-4 | 8.0 | 8.1 | A2-1 | 90.0 | 73.0 | MA | 2.0 | 18.9 |
| 31 | A1-5 | 8.0 | 8.1 | A2-1 | 90.0 | 73.0 | MA | 2.0 | 18.9 |

The abbreviations in Table 5 are as follows.
MA: Methacrylic acid
HA: Hexenoic acid
OA: Octenoic acid
ST: Styrene
TA: Trimellitic acid

TABLE 6

| | Physical properties | | | | | | |
|---|---|---|---|---|---|---|---|
| Amorphous | SPA1 − | | | | | | MwA/ |
| resin A | SPA2 | SPA | TA | Ws | MwAP | MwA | MwAP |
| 1 | 1.9 | 20.8 | 106.0 | 100.0 | 6000 | 18000 | 3.0 |
| 2 | 1.9 | 20.8 | 106.0 | 90.0 | 6000 | 18000 | 3.0 |
| 3 | 1.9 | 20.8 | 106.0 | 89.0 | 6000 | 18000 | 3.0 |
| 4 | 0.9 | 21.7 | 106.0 | 100.0 | 6000 | 18000 | 3.0 |
| 5 | 0.7 | 21.9 | 106.0 | 100.0 | 6000 | 18000 | 3.0 |
| 6 | 2.3 | 20.5 | 106.0 | 100.0 | 6000 | 18000 | 3.0 |
| 7 | 2.4 | 20.4 | 106.0 | 100.0 | 6000 | 18000 | 3.0 |
| 8 | — | 20.8 | 106.0 | 100.0 | 6000 | 18000 | 3.0 |
| 9 | 1.9 | 20.9 | 106.0 | 100.0 | 3000 | 18000 | 6.0 |
| 10 | 1.9 | 20.9 | 106.0 | 100.0 | 2900 | 18000 | 6.2 |
| 11 | 1.9 | 20.8 | 106.0 | 100.0 | 8000 | 18000 | 2.3 |
| 12 | 1.9 | 20.8 | 106.0 | 100.0 | 8100 | 18000 | 2.2 |
| 13 | 1.9 | 21.6 | 106.0 | 100.0 | 6000 | 18000 | 3.0 |
| 14 | 1.9 | 20.8 | 103.0 | 100.0 | 6000 | 10000 | 1.7 |
| 15 | 1.9 | 20.9 | 114.0 | 100.0 | 6000 | 100000 | 16.7 |
| 16 | 0.4 | 20.7 | 106.0 | 100.0 | 6000 | 18000 | 3.0 |
| 17 | −0.6 | 20.6 | 106.0 | 100.0 | 6000 | 18000 | 3.0 |
| 18 | — | 20.9 | 106.0 | 100.0 | 3000 | 18000 | 6.0 |
| 19 | — | 20.9 | 106.0 | 100.0 | 2900 | 18000 | 6.2 |
| 20 | — | 20.8 | 106.0 | 100.0 | 8000 | 18000 | 2.3 |
| 21 | — | 20.8 | 106.0 | 100.0 | 8100 | 18000 | 2.2 |
| 22 | — | 21.6 | 106.0 | 100.0 | 6000 | 18000 | 3.0 |
| 23 | — | 20.8 | 103.0 | 100.0 | 6000 | 10000 | 1.7 |
| 24 | — | 20.9 | 114.0 | 100.0 | 6000 | 100000 | 16.7 |
| 25 | — | 20.7 | 106.0 | 100.0 | 6000 | 18000 | 3.0 |
| 26 | — | 20.7 | 106.0 | 100.0 | 6000 | 18000 | 3.0 |
| 27 | 1.9 | 20.8 | 102.0 | 100.0 | 6000 | 9000 | 1.5 |
| 28 | 1.9 | 20.9 | 115.0 | 100.0 | 6000 | 105000 | 17.5 |
| 29 | 1.9 | 21.3 | 106.0 | 100.0 | 6000 | 18000 | 3.0 |
| 30 | −0.2 | 20.7 | 106.0 | 100.0 | 6000 | 18000 | 3.0 |
| 31 | −0.9 | 20.6 | 106.0 | 100.0 | 6000 | 18000 | 3.0 |

### Production Example of Amorphous Resin A-8

An NMR analysis of the above Amorphous resin A-1 revealed the presence of 9.9 mol % of monomer units derived from ethane diol, 46.1 mol % of monomer units derived from a propylene oxide adduct of bisphenol A (average number of added moles: 2.0 mol), 39.4 mol % of monomer units derived from terephthalic acid, and 4.6 mol % of monomer units derived from methacrylic acid.

Therefore, herein Amorphous resin A-8 was aimed at producing a random copolymer of Amorphous resin A-1.
Ethylene glycol: 1.4 parts (9.9 mol %)
Propylene oxide adduct of bisphenol A (average number of added moles: 2.0 mol): 72.6 parts (46.1 mol %)
Terephthalic acid: 24.0 parts (39.4 mol %)
Titanium tetrabutoxide (esterification catalyst): 0.5 parts

The above materials were weighed into a reaction tank equipped with a cooling tube, a stirrer, a nitrogen introduction tube and a thermocouple. Next, the interior of the tank was purged with nitrogen gas, and thereafter the temperature was gradually raised while under stirring; the reaction was conducted for 2 hours while under stirring at a temperature of 200° C.

The pressure in the reaction tank was lowered down to 8.3 kPa, the temperature was maintained at 200° C., and the reaction was allowed to proceed for 5 hours; once the weight-average molecular weight proved to have reached 6000, the following materials were added. Then the reaction was allowed to proceed for 2 hours, and once the softening point proved to have reached 106° C. in a measurement according to ASTM D36-86, the temperature was lowered to stop the reaction, and yield Amorphous resin A-8.
Methacrylic acid: 2.0 parts (4.6 mol %)
t-butyl peroxypivalate (by NOF Corporation: Perbutyl PV): 0.5 parts

The softening point TA of Amorphous resin A8 was 106° C., the weight-average molecular weight MwA of Amorphous resin A-8 was 18000, the weight-average molecular weight MwAP of the polyester units was 6000, and the proportion Ws of the THF-soluble fraction was 100.0 mass %.

An NMR analysis of the above Amorphous resin A-8 revealed the presence of 9.9 mol % of monomer units derived from ethylene glycol, 46.1 mol % of monomer units derived from a propylene oxide adduct of bisphenol A (average number of added moles: 2.0 mol), 39.4 mol % of monomer units derived from terephthalic acid, and 4.6 mol % of monomer units derived from methacrylic acid. The SP value of Amorphous resin A-8 was calculated in accordance with the above method; herein SP_{A} was 20.8 (Q/cm³)^{0.5}

### Production Examples of Amorphous Resin A-18 to Amorphous Resin A-26

Amorphous resin A-18 to Amorphous resin A-26 were obtained by performing a reaction as in the production example of Amorphous resin A-8, but modifying herein the type and parts by mass of the polymerizable monomers and of the straight-chain aliphatic polyhydric alcohol (a) as given in Table 7. The physical properties are given in Table 6.

TABLE 7

| | Target | Straight-chain | | | | | | | | | | | | | | |
|---|---|---|---|---|---|---|---|---|---|---|---|---|---|---|---|---|
| | block | aliphatic polyhydric | | | Polymerizable | | | Polymerizable | | | Polymerizable | | | Polymerizable | | |
| Amorphous | copolymer | alcohol (a) | | | monomer | | | monomer | | | monomer | | | monomer | | |
| resin A | Type | Type | Parts | mol % | Type | Parts | mol % | Type | Parts | mol % | Type | Parts | mol % | Type | Parts | mol % |
| 1 | — | Set out in separate table | | | | | | | | | | | | | | |
| 2 | — | Set out in separate table | | | | | | | | | | | | | | |
| 3 | — | Set out in separate table | | | | | | | | | | | | | | |
| 4 | — | Set out in separate table | | | | | | | | | | | | | | |
| 5 | — | Set out in separate table | | | | | | | | | | | | | | |
| 6 | — | Set out in separate table | | | | | | | | | | | | | | |
| 7 | — | Set out in separate table | | | | | | | | | | | | | | |
| 8 | 1 | ED | 1.4 | 9.9 | PO2 | 72.6 | 46.1 | TPA | 24.0 | 39.4 | — | — | — | MA | 2.0 | 4.6 |
| 9 | — | Set out in separate table | | | | | | | | | | | | | | |
| 10 | — | Set out in separate table | | | | | | | | | | | | | | |
| 11 | — | Set out in separate table | | | | | | | | | | | | | | |
| 12 | — | Set out in separate table | | | | | | | | | | | | | | |
| 13 | — | Set out in separate table | | | | | | | | | | | | | | |
| 14 | — | Set out in separate table | | | | | | | | | | | | | | |
| 15 | — | Set out in separate table | | | | | | | | | | | | | | |
| 16 | — | Set out in separate table | | | | | | | | | | | | | | |
| 17 | — | Set out in separate table | | | | | | | | | | | | | | |
| 18 | 9 | ED | 1.4 | 9.7 | PO2 | 71.6 | 44.8 | TPA | 24.0 | 38.8 | — | — | — | MA | 3.0 | 6.8 |
| 19 | 10 | ED | 1.4 | 9.7 | PO2 | 71.5 | 44.6 | TPA | 24.0 | 38.7 | — | — | — | MA | 3.1 | 7.0 |
| 20 | 11 | ED | 1.4 | 10.2 | PO2 | 75.0 | 49.3 | TPA | 23.1 | 39.3 | — | — | — | MA | 0.5 | 1.2 |
| 21 | 12 | ED | 1.4 | 10.2 | PO2 | 75.1 | 49.5 | TPA | 23.1 | 39.3 | — | — | — | MA | 0.4 | 1.0 |
| 22 | 13 | ED | 1.7 | 11.1 | PO2 | 45.0 | 26.5 | TPA | 24.0 | 36.5 | FA | 27.3 | 22.4 | ST | 2.0 | 3.5 |
| 23 | 14 | ED | 1.4 | 10.2 | PO2 | 74.4 | 48.7 | TPA | 24.0 | 40.6 | — | — | — | MA | 0.2 | 0.5 |
| 24 | 15 | ED | 1.4 | 9.4 | PO2 | 69.6 | 42.1 | TPA | 24.0 | 37.6 | — | — | — | MA | 5.0 | 10.9 |
| 25 | 16 | HD | 3.0 | 7.3 | PO2 | 71.0 | 46.9 | TPA | 24.0 | 41.0 | — | — | — | MA | 2.0 | 4.8 |
| 26 | 17 | DD | 4.1 | 6.1 | PO2 | 69.9 | 47.2 | ITPA | 24.0 | 41.8 | — | — | — | MA | 2.0 | 4.9 |

| | | |
|---|---|---|
| 27 | — | Set out in separate table |
| 28 | — | Set out in separate table |
| 29 | — | Set out in separate table |
| 30 | — | Set out in separate table |
| 31 | — | Set out in separate table |

The abbreviations in Table 7 are as follows.
ED: Ethanediol (ethylene glycol) (carbon number 2)
HD: Hexanediol (carbon number 6)
DD: Decanediol (carbon number 10)
PO2: propylene oxide adduct of bisphenol A (average number of added moles: 2.0 mol)
TPA: terephthalic acid
FA: Fumaric acid
MA: Methacrylic acid
ST: Styrene

### Production Example of Toner 1

Amorphous resin A-1: 75 parts
Crystalline polyester C1: 10 parts
Fischer-Tropsch wax (peak temperature 100° C. of maximum endothermic peak): 5 parts
Carbon black: 5 parts

The above materials were mixed using a Henschel mixer (FM-75 model, by Mitsui Kozan KK) at a rotational speed of 1500 rpm and for a rotation time of 5 min, followed by kneading using a twin-screw kneader (PCM-30 model, by Ikegai Corp.) set to a temperature of 130° C. The obtained kneaded product was cooled and was coarsely pulverized with a hammer mill, to a size of 1 mm or less, to yield a coarsely pulverized product. The obtained coarsely pulverized product was then finely pulverized using a mechanical pulverizer (T-250, by Turbo Kogyo Co., Ltd.). The resulting product was classified using Faculty (F-300, by Hosokawa Micron Corporation), to yield Toner particle 1. The operating conditions were set to a rotational speed of 11000 rpm of a classification rotor, and a rotational speed of 7200 rpm of a distribution rotor.
Toner particle 1: 95 parts
Large-diameter inorganic fine particles: fumed silica surface-treated with hexamethyldisilazane
(number-basis median diameter (D50) of 120 nm) 4 parts
Small-diameter inorganic fine particles: titanium oxide fine particles surface-treated with isobutyltrimethoxysilane
(number-basis median diameter (D50) of 10 nm) 1 part

The above materials were mixed using a Henschel mixer (FM-75 model, by Mitsui Miike Chemical Engineering Machinery Co., Ltd.) at a rotational speed of 1900 rpm and for a rotation time of 10 min, to yield Toner 1 exhibiting negative chargeability.

### Production Examples of Toner 2 to Toner 48

Toner 2 to Toner 48 were obtained by performing an operation similar to that of the production example of Toner 1, but modifying herein the types of the amorphous resin A and the crystalline polyester C as given in Table 8. Table 8 sets out the obtained physical properties.

Each amorphous resin A and each crystalline polyester C were separated from the respective obtained toners, in accordance with the procedures described above, and MwA, Tc and Ws were measured; results identical to the numerical values in Table 2 and Table 6 were obtained.

TABLE 8

| | Two- | | | Internal addition formulation/physical properties | | | | | |
|---|---|---|---|---|---|---|---|---|---|
| | component | | Magnetic | Amorphous | Crystalline | | | Ca − | SPA − |
| Example | developer | Toner | carrier | resin A | polyester C | Ca | Cc | Cc | SPC |
| No. | No. | No. | No. | No. | No. | — | — | — | — |
| 1 | 1 | 1 | 1 | 1 | 1 | 2 | 2 | 0 | 0.8 |
| 2 | 2 | 2 | 1 | 2 | 1 | 2 | 2 | 0 | 0.8 |
| 3 | 3 | 3 | 1 | 3 | 1 | 2 | 2 | 0 | 0.8 |
| 4 | 4 | 4 | 1 | 4 | 1 | 2 | 2 | 0 | 1.7 |
| 5 | 5 | 5 | 1 | 5 | 1 | 2 | 2 | 0 | 1.9 |
| 6 | 6 | 6 | 1 | 6 | 1 | 2 | 2 | 0 | 0.5 |
| 7 | 7 | 7 | 1 | 7 | 1 | 2 | 2 | 0 | 0.4 |
| 8 | 8 | 8 | 1 | 8 | 1 | 2 | 2 | 0 | 0.8 |
| 9 | 9 | 9 | 1 | 9 | 1 | 2 | 2 | 0 | 0.9 |
| 10 | 10 | 10 | 1 | 10 | 1 | 2 | 2 | 0 | 0.9 |
| 11 | 11 | 11 | 1 | 11 | 1 | 2 | 2 | 0 | 0.8 |
| 12 | 12 | 12 | 1 | 12 | 1 | 2 | 2 | 0 | 0.8 |
| 13 | 13 | 13 | 1 | 13 | 1 | 2 | 2 | 0 | 1.6 |
| 14 | 14 | 14 | 1 | 1 | 2 | 2 | 2 | 0 | 0.8 |
| 15 | 15 | 15 | 1 | 1 | 3 | 2 | 2 | 0 | 0.8 |
| 16 | 16 | 16 | 1 | 1 | 4 | 2 | 2 | 0 | 0.9 |
| 17 | 17 | 17 | 1 | 1 | 5 | 2 | 2 | 0 | 0.9 |
| 18 | 18 | 18 | 1 | 1 | 6 | 2 | 2 | 0 | 0.8 |
| 19 | 19 | 19 | 1 | 1 | 7 | 2 | 2 | 0 | 1.0 |
| 20 | 20 | 20 | 1 | 14 | 1 | 2 | 2 | 0 | 0.8 |
| 21 | 21 | 21 | 1 | 15 | 1 | 2 | 2 | 0 | 0.9 |
| 22 | 22 | 22 | 1 | 16 | 1 | 6 | 2 | 4 | 0.7 |
| 23 | 23 | 23 | 1 | 16 | 8 | 6 | 6 | 0 | 1.2 |
| 24 | 24 | 24 | 1 | 17 | 8 | 10 | 6 | 4 | 1.1 |
| 25 | 25 | 25 | 1 | 18 | 1 | 2 | 2 | 0 | 0.9 |
| 26 | 26 | 26 | 1 | 19 | 1 | 2 | 2 | 0 | 0.9 |
| 27 | 27 | 27 | 1 | 20 | 1 | 2 | 2 | 0 | 0.8 |
| 28 | 28 | 28 | 1 | 21 | 1 | 2 | 2 | 0 | 0.8 |
| 29 | 29 | 29 | 1 | 22 | 1 | 2 | 2 | 0 | 1.6 |
| 30 | 30 | 30 | 1 | 8 | 2 | 2 | 2 | 0 | 0.8 |
| 31 | 31 | 31 | 1 | 8 | 3 | 2 | 2 | 0 | 0.8 |
| 32 | 32 | 32 | 1 | 8 | 4 | 2 | 2 | 0 | 0.9 |
| 33 | 33 | 33 | 1 | 8 | 5 | 2 | 2 | 0 | 0.9 |
| 34 | 34 | 34 | 1 | 8 | 6 | 2 | 2 | 0 | 0.8 |
| 35 | 35 | 35 | 1 | 8 | 7 | 2 | 2 | 0 | 1.0 |
| 36 | 36 | 36 | 1 | 23 | 1 | 2 | 2 | 0 | 0.8 |
| 37 | 37 | 37 | 1 | 24 | 1 | 2 | 2 | 0 | 0.9 |
| 38 | 38 | 38 | 1 | 25 | 1 | 6 | 2 | 4 | 0.7 |
| 39 | 39 | 39 | 1 | 25 | 8 | 6 | 6 | 0 | 1.2 |
| 40 | 40 | 40 | 1 | 26 | 8 | 10 | 6 | 4 | 1.1 |
| C.E. 1 | 41 | 41 | 1 | 1 | 9 | 2 | 2 | 0 | 0.0 |
| C.E. 2 | 42 | 42 | 1 | 1 | 10 | 2 | 2 | 0 | 0.0 |
| C.E. 3 | 43 | 43 | 1 | 27 | 1 | 2 | 2 | 0 | 0.0 |
| C.E. 4 | 44 | 44 | 1 | 28 | 1 | 2 | 2 | 0 | 0.0 |
| C.E. 5 | 45 | 45 | 1 | 29 | 1 | 2 | 2 | 0 | 0.0 |
| C.E. 6 | 46 | 46 | 1 | 30 | 1 | 8 | 2 | 6 | 6.0 |
| C.E. 7 | 47 | 47 | 1 | 30 | 11 | 8 | 8 | 0 | 0.0 |
| C.E. 8 | 48 | 48 | 1 | 31 | 8 | 12 | 6 | 6 | 6.0 |

In the Table, “C.E.” indicates “Comparative example”.

### Production Example of Magnetic Carrier 1

Magnetite 1 having a number average particle diameter of 0.30 m (magnetization strength of 65 Am²/kg under a magnetic field of 1000/4π(kA/m))
Magnetite 2 having a number average particle diameter of 0.50 m (magnetization strength of 65 Am²/kg under a magnetic field of 1000/4π(kA/m))

A total of 4.0 parts of a silane compound (3-(2-aminoethylaminopropyl) trimethoxysilane) was added to 100 parts of each of the above materials, and the components were mixed and stirred at a high speed and at 100° C. or higher in a container to obtain fine particles of each type.
Phenol: 10% by mass
Formaldehyde solution: 6% by mass (formaldehyde 40% by mass, methanol 10% by mass, water 50% by mass)
Magnetite 1 treated with the silane compound: 58% by mass
Magnetite 2 treated with the silane compound: 26% by mass

A total of 100 parts of the above materials, 5 parts of a 28% by mass ammonia aqueous solution, and 20 parts of water were placed in a flask, the temperature was raised to 85° C. in 30 min and maintained while stirring and mixing, held for 3 h and the polymerization reaction was carried out, and the generated phenol resin was cured. Then, the cured phenol resin was cooled to 30° C., water was further added, the supernatant was removed, and the precipitate was washed with water, and then air-dried. Then, drying was performed under reduced pressure (5 mm Hg or less) at a temperature of 60° C. to obtain a magnetic body dispersion type spherical magnetic carrier 1. The volume-based 50% particle diameter (D50) of the magnetic carrier 1 was 34.21 μm.

### Production Example of Two-Component Developer 1

A total of 8.0 parts of toner 1 was added to 92.0 parts of the magnetic carrier 1 and mixing was performed with a V-type mixer (V-20, manufactured by Seishin Enterprise Co., Ltd.) to obtain a two-component developer 1.

### Production Examples of Two-Component Developers 2 to 48

Two-component developers 2 to 48 were obtained in the same manner as in the production example of two-component developer 1, except that changed as shown in Table 8.

### Example 1

Evaluation was performed using the two-component developer 1.

As an image forming device, a digital commercial printing printer imageRUNNER ADVANCE C5560 modified machine (commercially available from Canon Inc.) was used, and a two-component developer 1 was placed in a cyan developing device. As modifications of the device, a fixation temperature, a processing speed, a DC voltage V_{DC} of a developer bearing member, a charging voltage V_{D} of an electrostatic latent image bearing member, and a laser power could be freely set and changed. Image output evaluation was performed by outputting an FFh image (solid image) with a desired image ratio, and adjusting V_{DC}, V_{D}, and the laser power so that the amount of the toner of the FFh image laid on paper was a desired value, and the following evaluation was performed. FFh is a value indicating 256 gradations in hexadecimal, 00 h is the 1st gradation (white background) of 256 gradations, and FFh is the 256th gradation (solid portion) of 256 gradations. Evaluation was performed based on the following evaluation method, and the results are shown in Table 9.

### Abrasion Resistance

Paper: OK Top Coat Matte N (128.0 g/m²)
(sold by Canon Marketing Japan Inc.)
Laid-on level of toner on paper: 0.05 mg/cm² (2Fh image)
(adjusted on the basis of the DC voltage V_{D}C of the developer bearing member, the charging voltage V_{D} of the electrostatic latent image bearing member, and laser power)
Evaluation image: 3 cm×15 cm in the center of the above A4 paper
Fixing test environment: normal-temperature, normal-humidity environment (temperature 23° C./humidity 50% RH (hereafter N/N))
Fixation temperature: 180° C.
Process speed: 377 mm/see

The above evaluation image was outputted and abrasion resistance was evaluated. The value of the difference in reflectance was taken as an evaluation index of abrasion resistance. Firstly, a load of 0.5 kgf was applied to an image portion of the evaluation image using a Gakushin-type friction fastness tester (AB-301: by Tester Sangyo Co., Ltd.), with rubbing (10 back-and-forth rubs) using a new evaluation paper. Thereafter the reflectance of the rubbed portion and the reflectance of the non-rubbed portion of the new evaluation paper are measured using a reflectometer (REFLECTOMETER MODEL TC-6DS: by Tokyo Denshoku Co., Ltd.).

The difference in reflectance before and after rubbing was calculated on the basis of the expression below. The difference in the obtained reflectance was evaluated according to the evaluation criteria below. Ratings of A to C in the evaluation were deemed as good.

Difference in reflectance=reflectance before rubbing−reflectance after rubbing

### Evaluation Criteria

A: less than 1.0%
B: from 1.0% to less than 2.0%
C: from 2.0% to less than 4.0%
D: 4.0% or higher

### Low-Temperature Fixability

Paper: GFC-081 (81.0 g/m²) (commercially available from Canon Marketing Japan Inc.)
Amount of toner laid on paper: 0.50 mg/cm²
(adjusted by the DC voltage V_{D}C of the developer bearing member, the charging voltage V_{D} of the electrostatic latent image bearing member and the laser power)
Evaluation image: place a 2 cm×5 cm image in the center of the above A4 paper
Test environment: low temperature and low humidity environment: a temperature of 15° C./a humidity of 10% RH (hereinafter referred to as “L/L”)
Fixation temperature: 150° C.
Processing speed: 377 mm/see

The evaluation image was output and the low-temperature fixability was evaluated. The value of the rate of decrease in image density was used as an evaluation index for the low-temperature fixability.

Using an X-Rite Color Reflection Densitometer (500 series: commercially available from X-Rite), first, the image density at the center was measured. Next, a load of 4.9 kPa (50 g/cm²) was applied to the portion in which the image density was measured, the fixed image was rubbed (5 reciprocations) with lens-cleaning paper, and the image density was measured again.

Then, the rate of decrease in image density before and after friction was calculated using the following formula. The obtained rate of decrease in image density was evaluated according to the following evaluation criteria. If the evaluation was A to C, it was determined to be good.

Rate of decrease of image density(%)={(image density before friction)−(image density after friction)}/image density before friction×100

### Evaluation Criteria

A: the rate of decrease in image density was less than 3%
B: the rate of decrease in image density was 3% or more and less than 5%
C: the rate of decrease in image density was 5% or more and less than 8%
D: the rate of decrease in image density was 8% or more

### Example 2 to Example 40, and Comparative Example 1 to Comparative Example 8

Evaluations were performed in the same way as in Example 1, but using herein Two-component developer 2 through Two-component developer 48. The evaluation results are given in Table 9.

TABLE 9

| | Low-temperature fixability | | | | | |
|---|---|---|---|---|---|---|
| | | Image | Image | | Abrasion | |
| | | density | density | | resistance | |
| Example | | before | after | Rate of | | Reflectance |
| No. | | rubbing | rubbing | decrease | | difference |
| 1 | A | 1.35 | 1.32 | 2% | A | 0.0% |
| 2 | A | 1.35 | 1.32 | 2% | B | 1.8% |
| 3 | A | 1.35 | 1.32 | 2% | C | 2.5% |
| 4 | A | 1.35 | 1.32 | 2% | B | 1.8% |
| 5 | A | 1.35 | 1.32 | 2% | C | 2.5% |
| 6 | A | 1.35 | 1.32 | 2% | B | 1.8% |
| 7 | A | 1.35 | 1.32 | 2% | C | 2.5% |
| 8 | A | 1.35 | 1.32 | 2% | B | 1.1% |
| 9 | B | 1.35 | 1.31 | 3% | A | 0.0% |
| 10 | C | 1.35 | 1.28 | 5% | A | 0.0% |
| 11 | A | 1.35 | 1.32 | 2% | B | 1.8% |
| 12 | A | 1.35 | 1.32 | 2% | C | 2.5% |
| 13 | B | 1.35 | 1.31 | 3% | A | 0.0% |
| 14 | A | 1.35 | 1.32 | 2% | B | 1.8% |
| 15 | A | 1.35 | 1.32 | 2% | C | 2.5% |
| 16 | A | 1.35 | 1.32 | 2% | B | 1.8% |
| 17 | A | 1.35 | 1.32 | 2% | C | 2.5% |
| 18 | A | 1.35 | 1.32 | 2% | C | 2.5% |
| 19 | C | 1.35 | 1.28 | 5% | A | 0.0% |
| 20 | A | 1.35 | 1.32 | 2% | C | 2.5% |
| 21 | C | 1.35 | 1.28 | 5% | A | 0.0% |
| 22 | B | 1.35 | 1.31 | 3% | A | 0.0% |
| 23 | A | 1.35 | 1.32 | 2% | C | 2.5% |
| 24 | C | 1.35 | 1.28 | 5% | C | 2.5% |
| 25 | B | 1.35 | 1.31 | 3% | B | 1.1% |
| 26 | C | 1.35 | 1.28 | 5% | B | 1.1% |
| 27 | A | 1.35 | 1.32 | 2% | C | 2.5% |
| 28 | A | 1.35 | 1.32 | 2% | C | 3.9% |
| 29 | B | 1.35 | 1.31 | 3% | B | 1.1% |
| 30 | A | 1.35 | 1.32 | 2% | C | 2.5% |
| 31 | A | 1.35 | 1.32 | 2% | C | 3.9% |
| 32 | A | 1.35 | 1.32 | 2% | C | 2.5% |
| 33 | A | 1.35 | 1.32 | 2% | C | 3.9% |
| 34 | A | 1.35 | 1.32 | 2% | C | 3.9% |
| 35 | C | 1.35 | 1.28 | 5% | B | 1.1% |
| 36 | A | 1.35 | 1.32 | 2% | C | 3.9% |
| 37 | C | 1.35 | 1.28 | 5% | B | 1.1% |
| 38 | B | 1.35 | 1.31 | 3% | B | 1.1% |
| 39 | A | 1.35 | 1.32 | 2% | C | 3.9% |
| 40 | C | 1.35 | 1.28 | 5% | C | 3.9% |
| C.E. 1 | A | 1.35 | 1.32 | 2% | D | 4.0% |
| C.E. 2 | D | 1.35 | 1.22 | 10% | A | 0.0% |
| C.E. 3 | A | 1.35 | 1.32 | 2% | D | 4.0% |
| C.E. 4 | D | 1.35 | 1.22 | 10% | A | 0.0% |
| C.E. 5 | A | 1.35 | 1.32 | 2% | D | 4.0% |
| C.E. 6 | D | 1.35 | 1.22 | 10% | A | 0.0% |
| C.E. 7 | A | 1.35 | 1.32 | 2% | D | 4.0% |
| C.E. 8 | D | 1.35 | 1.22 | 10% | C | 2.5% |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-057837, filed Mar. 31, 2023, which is hereby incorporated by reference herein in its entirety.

What is claimed is:

1. A toner comprising a toner particle comprising a binder resin, wherein
the binder resin comprises an amorphous resin A and a crystalline polyester C,
the crystalline polyester C has, as a structure that forms a polyester, a structure corresponding to a straight-chain aliphatic polyhydric alcohol (c);
a carbon number Cc of the straight-chain aliphatic polyhydric alcohol (c) satisfies Expression (1) below:
$$2 \leq C c \leq 6 \qquad ( 1 )$$
the amorphous resin A has, as a structure that forms a polyester, a structure corresponding to a straight-chain aliphatic polyhydric alcohol (a);
a carbon number Ca of the straight-chain aliphatic polyhydric alcohol (a) satisfies Expression (2) below:
$$2 \leq C a \leq 10 \qquad ( 2 )$$
such that the Ca and the Cc satisfy Expression (3) below:
$$0 \leq \vert Ca - Cc \vert \leq 4 \qquad ( 3 )$$
the amorphous resin A has a structure in which a polyester is crosslinked with a vinyl polymer;
a weight-average molecular weight MwA measured from a tetrahydrofuran-soluble fraction of the amorphous resin A satisfies Expression (4) below:
$$10000 \leq MwA \leq 100000 , \qquad ( 4 )$$
and
a melting point Tc of the crystalline polyester C satisfies Expression (5) below:
$$90 ° C . \leq Tc \leq 100 ° C . \qquad ( 5 ) .$$

2. The toner according to claim 1, wherein the crystalline polyester C satisfies either or both of (A) and (B) below:
(A) the crystalline polyester C has a structure resulting from condensation of an aliphatic monocarboxylic acid having a carbon number of 15 to 31 with a hydroxy group at a main chain terminus; and
(B) the Crystalline polyester C has a structure resulting from condensation of an aliphatic monoalcohol having a carbon number of 15 to 30 with a carboxy group at a main chain terminus.

3. The toner according to claim 1, wherein the vinyl polymer has, as a structure that forms a vinyl polymer, a structure corresponding to (meth)acrylic acid.

4. The toner according to claim 1, wherein
with MwAP as a weight-average molecular weight measured from a tetrahydrofuran-soluble fraction of the polyester of the amorphous resin A,
the MwAP satisfies Expression (6) below:
$$3000 \leq M w A P \leq 8000 . \qquad ( 6 )$$

5. The toner according to claim 1, wherein
the polyester in the amorphous resin A is a block copolymer having an amorphous polyester segment A1 and an amorphous polyester segment A2; and
only the amorphous polyester segment A1 has a structure corresponding to the straight-chain aliphatic polyhydric alcohol (a).

6. The toner according to claim 5, wherein
with SPA1 being an SP value (J/cm³)^{0.5} of the amorphous polyester segment A1 and with SPA2 being an SP value (J/cm³)^{0.5} of the amorphous polyester segment A2,
the SPA1 and the SPA2 satisfy Expression (7) below:
$$0.8 \leq SPA 1 - SPA 2 \leq 2.5 . \qquad ( 7 )$$

7. The toner according to claim 1, wherein
the amorphous resin A is a main component of the binder resin, and
a proportion Ws (mass %) of a tetrahydrofuran-soluble fraction of the amorphous resin A referred to a mass of the amorphous resin A satisfies Expression (8) below:
$$90.0 \leq Ws \leq 10 \; 0.0 . \qquad ( 8 )$$

8. The toner according to claim 1, wherein the vinyl polymer comprises a poly(meth)acrylic acid.

9. The toner according to claim 1, wherein
the Ca is 2, and
the Cc is 2.

10. A two-component developer, containing a toner and a magnetic carrier, wherein
the toner is the toner comprising a toner particle comprising a binder resin, wherein
the binder resin comprises an amorphous resin A and a crystalline polyester C,
the crystalline polyester C has, as a structure that forms a polyester, a structure corresponding to a straight-chain aliphatic polyhydric alcohol (c);
a carbon number Cc of the straight-chain aliphatic polyhydric alcohol (c) satisfies Expression (1) below:
$$2 \leq C c \leq 6 \qquad ( 1 )$$
the amorphous resin A has, as a structure that forms a polyester, a structure corresponding to a straight-chain aliphatic polyhydric alcohol (a);
a carbon number Ca of the straight-chain aliphatic polyhydric alcohol (a) satisfies Expression (2) below:
$$2 \leq C a \leq 10 \qquad ( 2 )$$
such that the Ca and the Cc satisfy Expression (3) below:
$$0 \leq \vert Ca - Cc \vert \leq 4 \qquad ( 3 )$$
the amorphous resin A has a structure in which a polyester is crosslinked with a vinyl polymer;
a weight-average molecular weight MwA measured from a tetrahydrofuran-soluble fraction of the amorphous resin A satisfies Expression (4) below:
$$10000 \leq M w A \leq 100000 , \qquad ( 4 )$$
and
a melting point Tc of the crystalline polyester C satisfies Expression (5) below:
$$90 ° C . \leq Tc \leq 100 ° C . \qquad ( 5 ) .$$
